(19) United States
(12) Patent Application Publication
(10) Pub. No.: US 2025/0379669 A1
(43) Pub. Date: Dec. 11, 2025

(54) CROSS-LINK INTERFERENCE (CLI) MEASUREMENTS SUPPORTING FREQUENCY HOPPING

(71) Applicant: QUALCOMM Incorporated, San Diego, CA (US)

(72) Inventors: Huilin XU, Temecula, CA (US); Le LIU, San Jose, CA (US); Jing LEI, San Diego, CA (US); Chao WEI, Beijing (CN); Qunfeng HE, San Diego, CA (US); Yuwei REN, Beijing (CN)

(21) Appl. No.: 18/877,222

(22) PCT Filed: Aug. 9, 2022
(86) PCT No.: PCT/CN2022/111055

§ 371 Date: Dec. 19, 2024

(51) Int. Cl. H04B 17/345; H04L 5/00; H04W 24/10; H04W 72/0453

(52) U.S. Cl. CPC H04B 17/345; H04L 5/0012; H04W 24/10; H04W 72/0453

(57) ABSTRACT

Methods, systems, and devices for wireless communications are described. A user equipment (UE) may select frequency resources (e.g., which bandwidth (BW) or bandwidth part (BWP) of a frequency hopping pattern) in which to perform cross-link interference (CLI) measurements. The UE may select the BW or BWP in which to perform CLI based on a most recent downlink signal (e.g., any most recent downlink serving cell channel or downlink signal, or a most recent data message received via a physical downlink shared channel (PDSCH)). The UE may be configured with an anchor BW or BWP, in which to measure CLI. The UE may maintain multiple filters for multiple BWs or BWPs of a frequency hopping pattern, and may report CLI according to a filter result having the strongest CLI, or may report all filtered results for each BW or BWP. The UE may maintain a single filter.

### CROSS REFERENCE

The present Application is a 371 national stage filing of International PCT Application No. PCT/CN2022/111055 by XU et al. entitled “CROSS-LINK INTERFERENCE (CLI) MEASUREMENTS SUPPORTING FREQUENCY HOPPING,” filed Aug. 9, 2022, which is assigned to the assignee hereof, and which is expressly incorporated by reference in its entirety herein.

### TECHNICAL FIELD

The following relates to wireless communications, including cross-link interference (CLI) measurements supporting frequency hopping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support cross-link interference (CLI) measurements for frequency hopping. For example, a user equipment (UE) may select frequency resources (e.g., which bandwidth (BW) or bandwidth part (BWP) of a frequency hopping pattern) in which to perform CLI measurements. The UE may perform wideband CLI by maintaining a CLI filter across BWs or BWPs, and may be configured to measure CLI within only the active BW or BWP. In some examples, the UE may select the BW or BWP in which to perform CLI based on a most recent downlink signal (e.g., any most recent DL serving cell channel or downlink signal, or a most recent data message received via a physical downlink shared channel (PDSCH)). For instance, the UE may receive a downlink signal (e.g., via a PDSCH) on a particular BW or BWP using a beam, and may then select that same beam and the same BW or BWP to monitor for CLI during a CLI occasion. In some examples, the UE may be configured with an anchor BW or BWP in which to measure CLI. In some examples, the UE may report narrowband CLI. For example, the UE may maintain multiple filters for multiple BWs or BWPs of a frequency hopping pattern, and may report CLI according to a filter result having the strongest CLI, or may report all filtered results for each BW or BWP. In some examples, the UE may maintain a single filter, and an input for the filter may be a highest measured CLI of most recent instantaneous CLI measurements from all BWs or BWPs.

A method for wireless communications at a user equipment (UE) is described. The method may include receiving control signaling indicating a frequency hopping pattern, each frequency hop of the frequency hopping pattern associated with a respective set of frequency resources of a set of multiple frequency resources, selecting, from the set of multiple frequency resources, a first set of frequency resources associated with a first hop of the frequency hopping pattern on which to perform crosslink interference measurements based on a first downlink message, and performing cross-link interference measurements via the first set of frequency resources.

An apparatus for wireless communications at a UE is described. The apparatus may include at least one processor, memory coupled with the at least one processor, and instructions stored in the memory. The instructions may be executable by the at least one processor to cause the apparatus to receive control signaling indicating a frequency hopping pattern, each frequency hop of the frequency hopping pattern associated with a respective set of frequency resources of a set of multiple frequency resources, select, from the set of multiple frequency resources, a first set of frequency resources associated with a first hop of the frequency hopping pattern on which to perform cross-link interference measurements based on a first downlink message, and perform cross-link interference measurements via the first set of frequency resources.

Another apparatus for wireless communications at a UE is described. The apparatus may include means for receiving control signaling indicating a frequency hopping pattern, each frequency hop of the frequency hopping pattern associated with a respective set of frequency resources of a set of multiple frequency resources, means for selecting, from the set of multiple frequency resources, a first set of frequency resources associated with a first hop of the frequency hopping pattern on which to perform crosslink interference measurements based on a first downlink message, and means for performing cross-link interference measurements via the first set of frequency resources.

A non-transitory computer-readable medium storing code for wireless communications at a UE is described. The code may include instructions executable by at least one processor to receive control signaling indicating a frequency hopping pattern, each frequency hop of the frequency hopping pattern associated with a respective set of frequency resources of a set of multiple frequency resources, select, from the set of multiple frequency resources, a first set of frequency resources associated with a first hop of the frequency hopping pattern on which to perform crosslink interference measurements based on a first downlink message, and perform crosslink interference measurements via the first set of frequency resources.

Some examples of the method, apparatuses, and non-transitory computer-readable medium described herein may further include operations, features, means, or instructions for receiving the first downlink message via the first set of frequency resources according to the frequency hopping pattern using a first receive beam, where the selecting may be based on receiving the first downlink message via the first set of frequency resources and monitoring for cross-link interference via the first set of frequency resources using the first receive beam, where performing the cross-link interference measurements may be based on the monitoring.

In some examples of the method, apparatuses, and non-transitory computer-readable medium described herein, the first downlink message includes most recently received downlink message prior to performing the cross-link interference measurements.

In some examples of the method, apparatuses, and non-transitory computer-readable medium described herein, the first downlink message includes a data message received via a downlink shared channel.

Some examples of the method, apparatuses, and non-transitory computer-readable medium described herein may further include operations, features, means, or instructions for receiving control signaling indicating an anchor frequency range including the first set of frequency resources, where the selecting may be based on receiving the control signaling indicating the anchor frequency range and monitoring for cross-link interference via the first set of frequency resources, where performing the cross-link interference measurements may be based on the monitoring.

Some examples of the method, apparatuses, and non-transitory computer-readable medium described herein may further include operations, features, means, or instructions for determining that the first set of frequency resources satisfies a threshold bandwidth supported by the UE, where selecting the first set of frequency resources may be based on the receiving.

Some examples of the method, apparatuses, and non-transitory computer-readable medium described herein may further include operations, features, means, or instructions for selecting, from the set of multiple frequency resources, a second set of frequency resources associated with a second hop of the frequency hopping pattern on which to perform cross-link interference measurements, performing cross-link interference measurements via the second set of frequency resources, filtering the cross-link interference measurements, and transmitting a cross-link interference measurement report based on the filtering.

In some examples of the method, apparatuses, and non-transitory computer-readable medium described herein, filtering the cross-link interference measurements may include operations, features, means, or instructions for maintaining a single filter for each of the first set of frequency resources and the second set of frequency resources, where the cross-link interference measurement report includes a single set of filtered cross-link interference measurements for the set of multiple frequency resources.

In some examples of the method, apparatuses, and non-transitory computer-readable medium described herein, filtering the cross-link interference measurements may include operations, features, means, or instructions for maintaining a first filter for the first set of frequency resources and a second filter for the second set of frequency resources, determining a first level of cross-link interference associated with the first filter and a second level of cross-link interference associated with the second filter, the first level of cross-link interference being higher than the second level of cross-link interference, and including, in the cross-link interference measurement report based on the determining, a set of filtered cross-link interference measurements associated with the first filter.

In some examples of the method, apparatuses, and non-transitory computer-readable medium described herein, filtering the cross-link interference measurements may include operations, features, means, or instructions for maintaining a first filter for the first set of frequency resources and a second filter for the second set of frequency resources and including, in the cross-link interference measurement report, a first set of filtered cross-link interference measurements associated with the first filter and a second set of filtered cross-link interference measurements associated with the second filter.

Some examples of the method, apparatuses, and non-transitory computer-readable medium described herein may further include operations, features, means, or instructions for maintaining a first filter for the first set of frequency resources and the second set of frequency resources, where an input value for the first filter includes a highest level of cross-channel interference associated with a most recent cross-channel interference measurement for the first set of frequency resources and the second set of frequency resources.

In some examples of the method, apparatuses, and non-transitory computer-readable medium described herein, the set of multiple frequency resources include a bandwidth part and the first set of frequency resources includes a bandwidth within the bandwidth part.

In some examples of the method, apparatuses, and non-transitory computer-readable medium described herein, the set of multiple frequency resources include a set of multiple bandwidth parts and the first set of frequency resources includes a bandwidth part of the set of multiple bandwidth parts.

A method for wireless communications at a network entity is described. The method may include transmitting control signaling indicating a frequency hopping pattern, each frequency hop of the frequency hopping pattern associated with a respective set of frequency resources of a set of multiple frequency resources, receiving a cross-link interference measurement report corresponding to at least a first set of frequency resources associated with a first hop of the frequency hopping pattern on which a first UE has performed cross-link interference measurements based on a first downlink message, and scheduling wireless communications for a set of multiple UEs including the UE according to the frequency hopping pattern and based on receiving the cross-link interference measurement report.

An apparatus for wireless communications at a network entity is described. The apparatus may include at least one processor, memory coupled with the at least one processor, and instructions stored in the memory. The instructions may be executable by the at least one processor to cause the apparatus to transmit control signaling indicating a frequency hopping pattern, each frequency hop of the frequency hopping pattern associated with a respective set of frequency resources of a set of multiple frequency resources, receive a cross-link interference measurement report corresponding to at least a first set of frequency resources associated with a first hop of the frequency hopping pattern on which a first UE has performed cross-link interference measurements based on a first downlink message, and schedule wireless communications for a set of multiple UEs including the UE according to the frequency hopping pattern and based on receiving the cross-link interference measurement report.

Another apparatus for wireless communications at a network entity is described. The apparatus may include means for transmitting control signaling indicating a frequency hopping pattern, each frequency hop of the frequency hopping pattern associated with a respective set of frequency resources of a set of multiple frequency resources, means for receiving a cross-link interference measurement report corresponding to at least a first set of frequency resources associated with a first hop of the frequency hopping pattern on which a first UE has performed cross-link interference measurements based on a first downlink message, and means for scheduling wireless communications for a set of multiple UEs including the UE according to the frequency hopping pattern and based on receiving the cross-link interference measurement report.

A non-transitory computer-readable medium storing code for wireless communications at a network entity is described. The code may include instructions executable by at least one processor to transmit control signaling indicating a frequency hopping pattern, each frequency hop of the frequency hopping pattern associated with a respective set of frequency resources of a set of multiple frequency resources, receive a cross-link interference measurement report corresponding to at least a first set of frequency resources associated with a first hop of the frequency hopping pattern on which a first UE has performed cross-link interference measurements based on a first downlink message, and schedule wireless communications for a set of multiple UEs including the UE according to the frequency hopping pattern and based on receiving the cross-link interference measurement report.

Some examples of the method, apparatuses, and non-transitory computer-readable medium described herein may further include operations, features, means, or instructions for transmitting the first downlink message via the first set of frequency resources according to the frequency hopping pattern using a first transmit beam, where the cross-link interference measurement report includes cross-link interference measurements performed via the first set of frequency resources based on transmitting the first downlink message via the first set of frequency resources.

In some examples of the method, apparatuses, and non-transitory computer-readable medium described herein, the first downlink message includes most recently transmitted downlink message prior to a cross-link interference measurement occasion associated with the cross-link interference measurement report.

In some examples of the method, apparatuses, and non-transitory computer-readable medium described herein, the first downlink message includes a data message transmitted via a downlink shared channel.

Some examples of the method, apparatuses, and non-transitory computer-readable medium described herein may further include operations, features, means, or instructions for transmitting control signaling indicating an anchor frequency range including the first set of frequency resources, where the cross-link interference measurement report includes cross-link interference measurements performed via the anchor frequency range based on transmitting the control signaling indicating the anchor frequency range.

In some examples of the method, apparatuses, and non-transitory computer-readable medium described herein, the first set of frequency resources satisfies a threshold bandwidth supported by the UE.

In some examples of the method, apparatuses, and non-transitory computer-readable medium described herein, where the cross-link interference measurement report includes filtered cross-link interference measurements corresponding to the first set of frequency resources associated with the first hop of the frequency hopping pattern and a second set of frequency resources associated with a second hop of the frequency hopping pattern on which a first UE may have performed cross-link interference measurements.

In some examples of the method, apparatuses, and non-transitory computer-readable medium described herein, the cross-link interference measurement report includes a single set of filtered cross-link interference measurements for the set of multiple frequency resources.

In some examples of the method, apparatuses, and non-transitory computer-readable medium described herein, the cross-link interference measurement report includes a set of filtered cross-link interference measurements associated with a first level of cross-link interference associated with a first filter and the first set of frequency resources, the first level of cross-link interference being higher than a second level of cross-link interference associated with a second filter and the second set of frequency resources.

In some examples of the method, apparatuses, and non-transitory computer-readable medium described herein, the cross-link interference measurement report includes a first set of filtered cross-link interference measurements associated with a first filter and the first set of frequency resources and a second set of filtered cross-link interference measurements associated with a second filter and the second set of frequency resources.

In some examples of the method, apparatuses, and non-transitory computer-readable medium described herein, the cross-link interference measurement report includes a first set of filtered cross-link interference measurements associated with a first filter and the first set of frequency resources and the second set of frequency resources and the first set of filtered cross-link interference measurements may be based on a highest level of cross-channel interference associated with a most recent cross-channel interference measurement for the first set of frequency resources and the second set of frequency resources.

In some examples of the method, apparatuses, and non-transitory computer-readable medium described herein, the set of multiple frequency resources include a bandwidth part and the first set of frequency resources includes a bandwidth within the bandwidth part.

In some examples of the method, apparatuses, and non-transitory computer-readable medium described herein, the set of multiple frequency resources include a set of multiple bandwidth parts and the first set of frequency resources includes a bandwidth part of the set of multiple bandwidth parts.

### BRIEF DESCRIPTION OF THE DRAWINGS

FIG. 1 illustrates an example of a wireless communications system that supports cross-link interference (CLI) measurements for frequency hopping in accordance with one or more aspects of the present disclosure.

FIG. 2 illustrates an example of a wireless communications system that supports CLI measurements for frequency hopping in accordance with one or more aspects of the present disclosure.

FIG. 3 illustrates an example of a process flow that supports CLI measurements for frequency hopping in accordance with one or more aspects of the present disclosure.

FIGS. 4 and 5 show block diagrams of devices that support CLI measurements supporting frequency hopping in accordance with one or more aspects of the present disclosure.

FIG. 6 shows a block diagram of a communications manager that supports CLI measurements for frequency hopping in accordance with one or more aspects of the present disclosure.

FIG. 7 shows a diagram of a system including a device that supports CLI measurements for frequency hopping in accordance with one or more aspects of the present disclosure.

FIGS. 8 and 9 show block diagrams of devices that support CLI measurements supporting frequency hopping in accordance with one or more aspects of the present disclosure.

FIG. 10 shows a block diagram of a communications manager that supports CLI measurements for frequency hopping in accordance with one or more aspects of the present disclosure.

FIG. 11 shows a diagram of a system including a device that supports CLI measurements for frequency hopping in accordance with one or more aspects of the present disclosure.

FIGS. 12 through 16 show flowcharts illustrating methods that support CLI measurements supporting frequency hopping in accordance with one or more aspects of the present disclosure.

### DETAILED DESCRIPTION

In some wireless communications systems, user equipments (UEs) may be configured to perform frequency hopping over time. The frequency hopping may include hopping among different sets of frequency resources (e.g., from bandwidth (BW) to BW within a bandwidth part (BWP), or from BWP to BWP within one or more frequency bands. Frequency hopping may improve throughput and support channel frequency diversity. For example, one or more supported UEs may support narrowband communications (e.g., may not be capable of communicating across a large range of frequency resources). By implementing a frequency hopping scheme, such a UE may exploit channel frequency diversity and improve the reliability and throughput of wireless communications, despite communicating on one narrowband at a time. However, a UE may experience cross-link interference (CLI) (e.g., if the UE is receiving downlink signaling on resources used by another UE transmitting uplink signaling). To mitigate or avoid CLI, a network entity may signal, indicate or configure a UE to perform CLI measurements (e.g., may provide or signal to the UE CLI measurement resources via which the UE may measure interference from other links). The UE may then report CLI to the network.

A UE may experience different levels of CLI in different frequency hops. Additionally, if the UE supports frequency hopping, then the UE may perform CLI measurements in between frequency hops. If a UE is unable to identify frequency resources on which to perform CLI measurements (e.g., in which BWP or which BW to perform CLI measurements during a CLI measurement occasion), or if the UE only performs limited CLI measurements (e.g., CLI measurements that are not frequency dependent or are not representative of a full range of frequency resources), then the UE may not report a complete representation of CLI to the network, resulting in increased CLI, decreased reliability of wireless communications, failed transmissions, increased retransmissions, degraded quality of communication, and increased system latency.

To address these and other issues, a UE may select frequency resources (e.g., which BW or BWP of a frequency hopping pattern) in which to perform CLI. The UE may perform wideband CLI by maintaining a CLI filter across BWs or BWPs, and may be instructed or configured to measure CLI within only the active BW or BWP. In some examples, the UE may select the BW or BWP in which to perform CLI based on a most recent downlink signal (e.g., any most recent DL serving cell channel or downlink signal, or a most recent data message received via a physical downlink shared channel (PDSCH)). For instance, the UE may receive a downlink signal (e.g., via a PDSCH) on a particular BW or BWP using a beam, and may then select that same beam and the same BW or BWP on which to monitor for CLI during a CLI occasion. In some examples, the UE may receive an indication of (e.g., may be configured with) or may determine an anchor BW or BWP, in which to measure CLI. In some examples, the UE may report narrowband CLI. For example, the UE may maintain multiple filters for multiple BWs or BWPs of a frequency hopping pattern, and may report CLI according to a filter result having the strongest CLI, or may report all filtered results for each BW or BWP. In some examples, the UE may maintain a single filter, and an input for the filter may be a highest measured CLI of most recent instantaneous CLI measurements from all BWs or BWPs.

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to CLI measurements supporting frequency hopping.

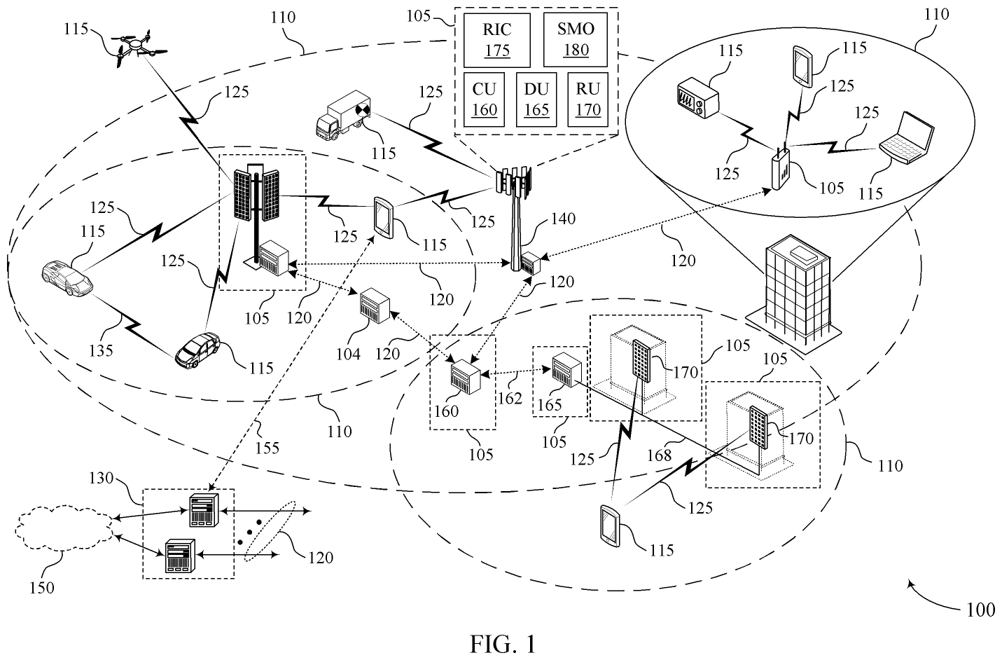

FIG. 1 illustrates an example of a wireless communications system 100 that supports CLI measurements for frequency hopping in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support CLI measurements supporting frequency hopping as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device, etc.), a camera, a gaming device, a navigation/positioning device (e.g., GNSS (global navigation satellite system) devices based on, for example, GPS (global positioning system), Beidou, GLONASS, or Galileo, or a terrestrial-based device, etc.), a tablet computer, a laptop computer,, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular BW of the RF spectrum and, in some examples, the carrier BW may be referred to as a “system BW” of the carrier or the wireless communications system 100. For example, the carrier BW may be one of a set of BWs for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier BW or may be configurable to support communications using one of a set of carrier BWs. In some examples, the wireless communications system 100 may include network entities 105 or UEs 115 that support concurrent communications using carriers associated with multiple carrier BWs. In some examples, each served UE 115 may be configured for operating using portions (e.g., a sub-band, a BWP) or all of a carrier BW.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system BW or a subset of the system BW of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system BW or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may select frequency resources (e.g., which BW or BWP of a frequency hopping pattern) in which to perform CLI. The UE 115 may perform wideband CLI by maintaining a CLI filter across BWs or BWPs, and may measure CLI within only the active BW or BWP. In some examples, the UE 115 may select the BW or BWP in which to perform CLI based on a most recent downlink signal (e.g., any most recent DL serving cell channel or downlink signal, or a most recent data message received via a physical downlink shared channel (PDSCH)). For instance, the UE may receive a downlink signal (e.g., via a PDSCH) on a particular BW or BWP using a beam, and may then select that same beam and the same BW or BWP on which to monitor for CLI during a CLI occasion. In some examples, the UE 115 may determine (e.g., may receive an indication of) an anchor BW or BWP, in which to measure CLI. In some examples, the UE 115 may report narrowband CLI. For example, the UE may maintain multiple filters for multiple BWs or BWPs of a frequency hopping pattern, and may report CLI according to a filter result having the strongest CLI, or may report all filtered results for each BW or BWP. In some examples, the UE may maintain a single filter, and an input for the filter may be a highest measured CLI of most recent instantaneous CLI measurements from all BWs or BWPs.

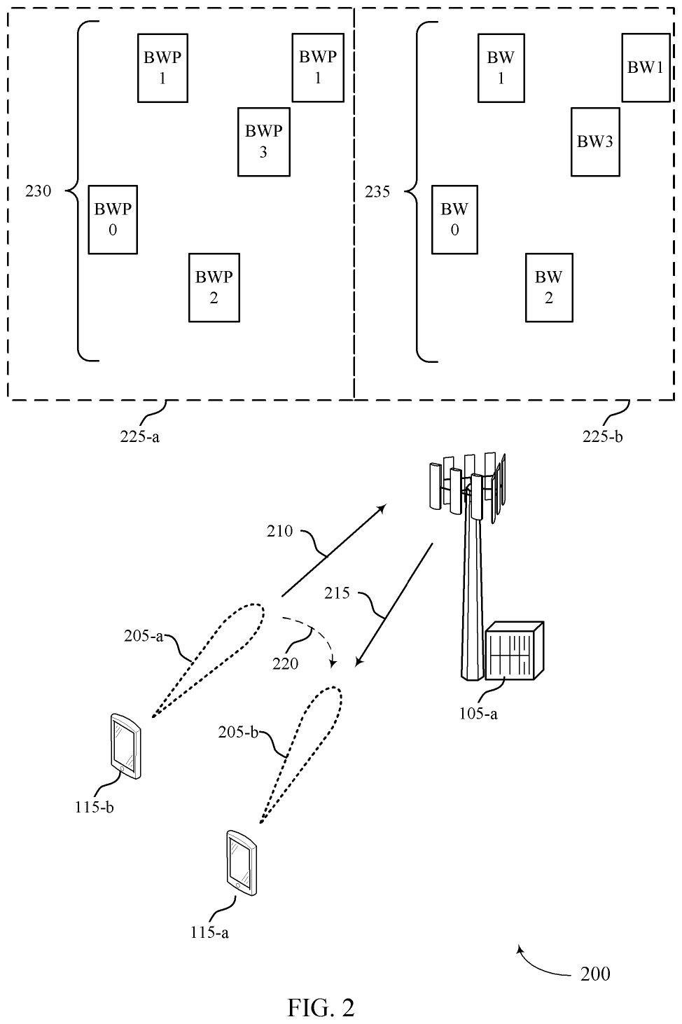

FIG. 2 illustrates an example of a wireless communications system 200 that supports CLI measurements for frequency hopping in accordance with one or more aspects of the present disclosure. The wireless communications system 200 may implement aspects of, or be implemented by aspects of, the wireless communications system 100. For example, the wireless communications system 200 may include a network entity 105-a, and one or more UEs 115 (e.g., the UE 115-a and the UE 115-b), which may be examples of corresponding devices described with reference to FIG. 1.

The UEs 115 may communicate with the network entity 105-a via one or more beams 205. For example, the UE 115-b may transmit uplink signaling 210 via a beam 205-a (e.g., a transmit beam), and the UE 115-a may receive downlink signaling 215 via the beam 205-b (e.g., a receive beam).

One or more UEs 115 may experience CLI 220 when a transmission by one UE 115 (e.g., the uplink signaling 210 by the UE 115-b) interferes with reception by another UE 115 (e.g., the downlink signaling 215 sent to the UE 115-a). For example, the network entity 105-a may support full duplex functionality. In such examples, the network entity 105-a may receive the uplink signaling 210 and transmit the downlink signaling 215 simultaneously. However, if the UE 115-a is monitoring for the downlink signaling 215 at the same time the UE 115-b is transmitting the uplink signaling 210, then the UE 115-a may experience the CLI 220 (e.g., in attempting to receive the downlink signaling 215, the uplink signaling 210 may interfere with the reception of the downlink signaling 215). To mitigate CLI, the network (e.g., via the network entity 105-a) may signal one or multiple CLI measurement resources for measuring CLI. During each CLI resource, the UE 115-a may monitor for and measure CLI, and may report the CLI to the network.

In some examples, one or more UEs 115 may support frequency hopping. Such UEs 115 may hop (e.g., change) from one frequency range to another frequency range according to a frequency hopping pattern 225. Frequency hopping may enable a UE 115 that supports narrowband communications to exploit channel frequency diversity. For example, the UE 115-a may be a reduced capability (RedCap) UE, or an enhanced or evolved RedCap (eRedCap) UE, among other examples, and may support a narrow BW for reduced capability UE designs. In such examples, if the UE 115-a only communicates via a single narrowband, the UE 115-a may be limited by availability of system resources within that band, and may not be able to exploit channel diversity (e.g., although the UE 115-a may experience interference or channel fading on one band, communications may be more reliable on another band). Thus, by performing frequency hopping, the UE 115-a may improve reliability of communications and exploit channel frequency diversity, improve throughput, and improve user experience, despite supporting narrowband communications (e.g., and not supporting wideband communications).

Frequency hopping may be performed according to a frequency hopping pattern 225. The network entity 105-a may signal, indicate, or configure the UE 115-a with a frequency hopping pattern 225. For example, according to frequency hopping pattern 225-a, frequency hopping for the UE 115-a may be supported by frequency hopping among different BWPs having different center frequencies within a total supported range of frequency resources 230. In such examples, the UE 115-a may switch (e.g., may adjust one or more antennas or antenna panels, one or more receive chains or transmit chains, or any other parameters, among other examples) between BWP0 to BWP1, to BWP2, to BWP3, and back to BWP1, according to frequency hopping pattern 225-a. The BWPs of the frequency hopping pattern 225-a may be contiguous in time, or may be non-contiguous in time. For example, the UE 115-a may receive an indication of (e.g., or may otherwise determine) a CLI measurement occasion that occurs between hops of the frequency hopping pattern 225-a. According to frequency hopping pattern 225-b, the UE 115-a may hop among different narrowband BWs within a same BWP 235. For example, the UE 115-a may switch from BW0, to BW1, to BW2, to BW3, and back to BW1, according to the frequency hopping pattern 225-b. The BWs of the frequency hopping pattern 225-b may be contiguous in time, or may be non-contiguous in time. For example, the UE 115-a may identify a CLI measurement occasion that occurs between hops of the frequency hopping pattern 225-b.

In both the frequency hopping pattern 225-a and the frequency hopping pattern 225-b, frequency resources for uplink or downlink communications may be based on (e.g., may not exceed) a threshold (e.g., maximum) BW supported by the UE. For example, if the UE 115-a is capable of supporting communication across a full BWP, then the network entity 105-a may signal, indicate, or configure the UE 115-a with the frequency hopping pattern 225-a. Alternatively, if the UE 115-a is not capable of supporting communications across a full BWP (e.g., but is capable of supporting various narrowband BWs within a BWP 235), then the network entity 105-a may signal, indicate, or configure the UE 115-a with the frequency hopping pattern 225-b.

To avoid or mitigate CLI, the network entity 105-a may signal, indicate, or configure the UE 115-a with one or more CLI measurement occasions during which the UE 115-a may monitor for and measure CLI. Various UEs 115 (e.g., a UE 115-a that supports wideband communications) may coexist with narrowband UEs 115 (e.g., such as the UE 115) in the wireless communications system 200. CLI may occur when the network entity 105-a in a cell supports full duplex functionality, or when a neighbor cell configures different time division duplexing (TDD) downlink and uplink slot formats. The network entity 105-a may signal, indicate, or configure the coexisting UEs 115 with various CLI measurement occasions during which the UE 115-a may perform CLI measurements. In some examples, the network entity 105-a may also signal for other UEs 115 to transmit uplink signaling during the CLI measurement occasions.

In some examples, UEs 115 performing CLI measurements may measure CLI in an active BWP. However, if the UE 115-a supports frequency hopping pattern 225-a, the UE 115-a may not be able to determine in which BWP to perform CLI measurement (e.g., or may perform CLI in a single BWP, despite CLI varying across the frequency resources 230). Similarly, if the UE 115-a supports frequency hopping pattern 225-b, then the UE 115-a may not be able to perform CLI measurement across the full BWP 235. Further, the UE 115-a may not have a mechanism by which to determine in which BW the UE 115-a is to perform CLI measurements, within an active BWP 235. Techniques described herein supports means by which the UE 115-a is to determine on which frequency resources (e.g., on which BWP of the frequency resources 230 or on which BW of the BWP 235) to perform CLI measurements.

In some examples, UEs 115 may perform instantaneous CLI measurements, and may filter CLI measurements performed over time (e.g., via layer 3 (L3) filtering procedures). If a BWP switch or BW switch does not occur very often, UEs 115 may autonomously determine whether to reset L3 filters of instantaneous CLI measurements when BWP switching occurs. However, BWP or BW switching may occur regularly in a frequency hopping scenario.

Filtering for various measurements (e.g., including CLI measurements) may be performed by the UE 115-a. The UE 115-a may filter measured CLI results, before using the CLI measurement results for evaluation of reporting criteria for CLI measurement reporting, by applying equation 1:

$${F}_{n} = ( 1 - a ) * {F}_{n - 1} + a * {M}_{n} \qquad Equation 1$$

where Mₙ represents a latest (e.g., most recent) received measurement result from the physical layer, Fₙ represents an updated filter measurement result that is used for evaluation of reporting criteria for CLI measurement reporting, Fₙ₋₁ represents a previous filtered measurement result, and F₀ is set to M₁ when the first measurement result from the physical layer is received. For a given measurement object,

$$a = 1 / {2}^{\frac{{k}_{i}}{4}} ,$$

where kᵢ represents a filter coefficient for the corresponding measurement quality of the ith item in a list (e.g., as defined by a higher layer parameter such as quantityConfigNR in a quantityConfigNR-List). In such examples, i may be indicated by an index value for a measurement object. For other measurements,

$$a = 1 / {2}^{\frac{k}{4}} ,$$

where k represents a filter coefficient for the corresponding measurement quantity received via higher layer signalling (e.g., quantityConfig or quantityConfigrUTRA-FDD in QuantityConfig).

Thus, if the UE maintains a filter over time, the output of the filtering may represent an updated filter measurement based on current and previous measurements. However, if the UE resets the filter (e.g., sets Fₙ₋₁ to Mₙ for the nth measurement), then the measurement may not be based on previous measurements. Techniques described herein provide rules and conditions under which the UE 115-a is to maintain an L3 filter for CLI measurements across frequency resources 230 or BWP 235, or reset L3 filters for individual BWPs or BWs.

CLI may change across different frequency resources, and if the UE 115-a is limited as to which frequency resources to measure for CLI (e.g., if the UE 115-a only measures CLI in a single BW or BWP), then the UE 115-a may report incomplete or inaccurate CLI measurements to the network entity, resulting in scheduling of downlink signaling that may be degraded by CLI. In some examples, performing CLI measurements across a wider BW, or providing CLI measurement reports for individual BWPs or BWs may result in improved CLI mitigation. Additionally, or alternatively, if the UE 115-a supports a frequency hopping pattern 225, then the UE 115-a could monitor for CLI in any given hop of the frequency hopping pattern 225. For instance, if the UE 115-a supports the frequency hopping pattern 225-a, for a CLI measurement occasion that occurs between a first frequency hop on BWP 0 and a second frequency hop on BWP 1, it may not be clear on which frequency resources (e.g., BWP0 or BWP1, or any other BWP such as BWP 3) the UE 115-a is instructed to perform CLI measurements. If the UE 115-a performs CLI measurements on frequency resources that do not align with uplink transmissions (e.g., performed by another UE 115-b as signaled by the network entity 105-a), then the UE 115-a may fail to detect CLI, and may transmit an incomplete or inaccurate CLI measurement report to the network entity 105-a. Similarly, if the UE 115 does not measure CLI across a variety of available frequency resources, then the CLI measurements may be incomplete. Such scenarios may result in increased CLI in subsequent communications, degraded quality of communications, inefficient use of system resources, and decreased user experience.

Techniques described herein support L3 filtering of instantaneous CLI measurement results across frequency hops, determination of frequency resources (e.g., which BWP or BW) for performing CLI measurements, content of CLI measurement reports based on CLI measurement techniques and filtering techniques, and strong frequency dependent CLI measurements in filtered CLI. Although illustrated and described with reference to the UE 115-a, such techniques may be performed by any wireless node (e.g., a UE, a RedCap UE, an eRedCap UE, or any other wireless device performing CLI measurements). Similarly, although illustrated with reference to frequency hopping pattern 225-a and frequency hopping pattern 225-b, a UE 115 may perform frequency hopping according to any frequency hopping pattern (e.g., including various BWPs, BWs, or any other segmentation or ordering of sets of frequency resources).

In some examples, the UE 115-a may perform long-term wideband CLI measurement, filtering, and reporting. In such examples (e.g., for a frequency hopping pattern 225-a or a frequency hopping pattern 225-b), the UE 115-a may maintain an L3 filter for CLI measurements across frequency hops (e.g., across BWPs or BWs). In some examples, the UE 115-a may perform CLI measurements in an active BWP. For example, in frequency hopping pattern 225-a, the UE 115-a may perform CLI measurements (e.g., during a CLI measurement occasion) on whichever BWP of the frequency hopping pattern 225-a that is activated. By filtering CLI measurements across frequency hops (e.g., in various activated BWPs over time), the UE 115-a may generate a wideband CLI measurement report for the frequency resources 230, which the UE 115-a may report to the network entity 105-a. If the UE 115-a is a narrowband UE operating according to the frequency hopping pattern 225-b, the UE 115-a may not be expected to measure CLI across the entire BWP 235 (e.g., which may be beyond a threshold BW capacity of the UE 115-a). The UE 115-a may maintain an L3 filter across frequency hops (e.g., in various activated BWs over time) of the frequency hopping pattern 225-b, and may report a CLI for the full BWP 235 based thereon.

In some examples, the UE 115-a may select frequency resources (e.g., a BWP or a BW) in which to perform CLI measurements based on a recently received signal. For example, a CLI measurement occasion may occur between frequency hops (e.g., between the occurrence of BWP 0 and BWP 1, or between the occurrence of BWP 1 and BWP 2 of frequency hopping pattern 225-a). In such examples, the UE 115-a may measure CLI in a BW or BWP of a frequency hop containing a most recently received downlink message (e.g., a most recent downlink service cell channel, or a most recent downlink signal received by the UE 115-a, among other examples). For example, in a frequency hopping pattern 225-a, the UE 115-a may receive downlink signaling (e.g., on a PDCCH, a PDSCH, a CSI-RS, among other examples) via BWP 0. Subsequent to the reception (e.g., but prior to receiving any downlink signaling via BWP 1), the UE 115-a may perform CLI measurements by monitoring for CLI via the frequency resources of BWP 0 (e.g., the BWP in which the UE 115-a received downlink signaling most recently prior to the CLI measurement occasion). Similarly, after receiving downlink signaling via the BWP 3 (e.g., but prior to receiving downlink signaling via the BWP 1), the UE 115-a may perform CLI measurements using the frequency resources of the BWP 3. If the UE 115-a reports wideband CLI, the UE 115-a may maintain an L3 filter across the CLI measurements in BWP 0 and BWP 3, and may report filtered CLI measured across at least BWP 0 and BWP 3. In a frequency hopping pattern 225-b, the UE 115-a may perform CLI using frequency resources of a BWP 235 in a BW in which any downlink serving cell channel, or downlink signal is received by the UE 115-a. For example, the UE 115-a may receive downlink signaling (e.g., on a PDCCH, a PDSCH, a CSI-RS, among other examples) via BW 0. Subsequent to the reception (e.g., but prior to receiving any downlink signaling via BW 1), the UE 115-amay perform CLI measurements by monitoring for CLI via the frequency resources of BW 0 (e.g., the BW in which the UE 115-a received downlink signaling most recently prior to the CLI measurement occasion). Similarly, after receiving downlink signaling via the BW 3 (e.g., but prior to receiving downlink signaling via the BW 1), the UE 115-a may perform CLI measurements using the frequency resources of the BW 3. If the UE 115-a reports wideband CLI, the UE 115-a may maintain an L3 filter across the CLI measurements in BW 0 and BW 3, and may report filtered CLI measured across at least BW 0 and BW 3.

In some examples, the UE 115-a may perform CLI measurements by monitoring frequency resources in a most recent BWP or BW in which the UE 115-a received downlink signaling via a PDSCH. For example, in a frequency hopping pattern 225-a, if the UE 115-a receives downlink data signaling via the BWP 0, then the UE 115-a may perform CLI measurements via the frequency resources of the BWP 0 at a next CLI measurement occasion (e.g., if no other downlink signaling on a PDSCH has been received during any intervening frequency hops). In another example, in a frequency hopping pattern 225-b, if the UE 115-a receives downlink data signaling via the BW 0, then the UE 115-a may perform CLI measurements via the frequency resources of the BW 0 at a next CLI measurement occasion (e.g., if no other downlink signaling on a PDSCH has been received during any intervening frequency hops).

In some examples, the UE 115-a may autonomously select a BWP or BW in which to perform CLI measurements. For example, the UE 115-a may perform wireless communications in BW0, BW1, BW2, and BW3 according to frequency hopping pattern 225-b. During each CLI measurement occasion, the UE 115-a may select one of the BWs on which to perform the CLI measurements. The UE 115-a may select the BWs randomly, or based on a rule (e.g., may perform CLI measurement in BWs in which the UE 115-a most recently received any downlink signaling, or most recently received signaling via a PDSCH, randomly selected BWs, or a pattern or ordering of BWs or BWPs, among other examples). The UE 115-a may similarly autonomously select a BWP in a frequency hopping pattern 225-a. To measure wideband CLI, the UE 115-a may maintain L3 filtering across hops within the BWP 235, or across hops within the frequency resources 230.

In some examples, the UE 115-a may measure CLI based on an anchor frequency BW or BWP. For example, if frequency hopping is supported by the UE 115-a, the network may signal, indicate, or configure an anchor frequency BW for the UE 115-a to measure CLI. If frequency hopping is based on different BWPs (e.g., frequency hopping pattern 225-a), then an anchor BWP may be determined (e.g., may be indicated by the network entity 105-a via higher layer or other control signaling, or determined by the UE 115-a). If frequency hopping is performed within a wide BWP 235 (e.g., frequency hopping pattern 225-b), then an anchor frequency BW within the BWP may be determined (e.g., may be indicated by the network entity 105-a via higher layer or other control signaling, or determined by the UE 115-a).

A UE 115-a may measure and report narrowband CLI. In such examples, the UE 115-a may measure and report frequency dependent CLI. The network entity 105-a may signal, indicate, or configure the UE 115-a (e.g., with frequency hopping supported) for narrowband CLI measurements. For example, the network entity 105-a may transmit control signaling configuring CLI measurement occasions, instructing the UE 115-a to perform narrowband CLI measurements, or a combination thereof.

The UE 115-a may separately maintain CLI filters for different hopping frequency BWs or BWPs. For example, the UE 115-a may maintain one filter for each BWP of frequency hopping pattern 225-a, or one filter for each BW of frequency hopping pattern 225-b. The UE 115-a may perform CLI measurements on each BW or BWP of a respective frequency hopping pattern 225 (e.g., based on an instruction from the network entity, based on a most recently received downlink message, based on a mapping between CLI measurement occasions and BWs or BWPs, among other examples). The UE 115-a may report CLI measurements to the network entity 115-a. The CLI measurement report may include an averaged filtered CLI measurement across all filters, which may be the equivalent of a wideband CLI measurement. The CLI measurement report may include a filtered measurement result corresponding to the filter having the strongest CLI measurement result among all of the maintained filters. For example, the UE 115-a may perform CLI measurements for each BWP of the frequency hopping pattern 225-a, and may maintain four filters (e.g., one for each of the four BWPs). The UE 115-a may determine which filter results in the highest measured CLI (e.g., the most detected CLI over time according to the maintained filter), and may report a narrowband CLI measurement report for the determined BWP (e.g., or the BW having the highest CLI measurement in a frequency hopping pattern 225-b). In some examples, the UE 115-a may include, in the CLI measurement report, individual filtered measurement results for each of the maintained filters (e.g., a filtered CLI measurement for each BWP or each BW).

In some examples, the UE 115-a may maintain a single filter for each set of frequency resources (e.g., each BW or BWP of a frequency hopping pattern 225). The input for the maintained filter may be a threshold (e.g., highest) CLI measurement of a most recent instantaneous CLI measurement for all BWPs or BWs of a frequency hopping pattern 225.

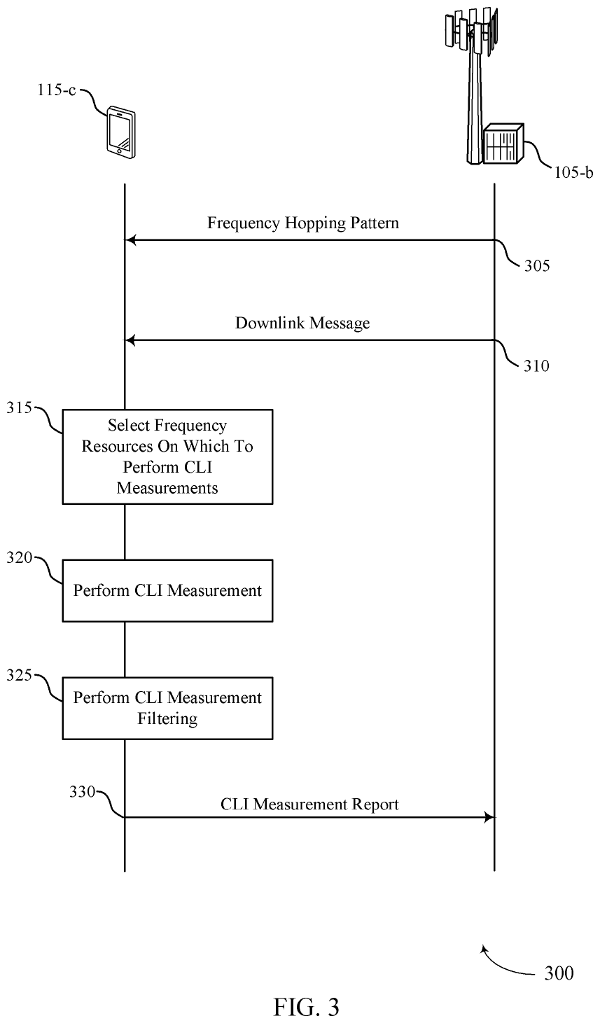

FIG. 3 illustrates an example of a process flow 300 that supports CLI measurements for frequency hopping in accordance with one or more aspects of the present disclosure. Process flow 300 may implement aspects of, or be implemented by aspects of, wireless communications system 100 and wireless communications system 200. For example, the process flow 300 may include a network entity 105-b, and a UE 115-c, which may be examples of corresponding devices described with reference to FIGS. 1-2.

At 305, the UE 115-c may receive (e.g., from the network entity 105-b) control signaling (e.g., RRC signaling). The control signaling may indicate a frequency hopping pattern (e.g., such as a frequency hopping pattern 225-a or a frequency hopping pattern 225-b). Each hop of the frequency hopping pattern may be associated with a respective set of frequency resources (e.g., BWs or BWPs) of a range of frequency resources (e.g., frequency resources 230 or BWP 235).

In some examples, the UE 115-c may receive (e.g., in the same control signaling at 305 or different control signaling) configuration information for CLI measurements and CLI measurement reporting. For example, the network entity 105-b may signal, indicate, or configure the UE 115-c with CLI measurement occasions during which to perform CLI measurements. The UE may select frequency resources via which to perform the CLI measurements at 315. For example, the CLI measurement occasions may be configured for a full BWP or a full frequency band. The UE 115-c may not be capable of performing CLI measurement across a full band or BWP simultaneously. The UE 115-c may instead select a set of frequency ranges (e.g., a BW or BWP) via which to perform the CLI measurements.

At 310, the UE 115-c may receive a downlink message. As described herein the downlink message may be a downlink control message (e.g., on a PDCCH) a downlink data message (e.g., on a PDSCH), a configuration message (e.g., indicating an anchor channel), among other examples.

At 315, the UE 115-c may select a set of frequency resources on which to perform CLI measurements. The UE 115-c may select a first set of frequency resources associated with a first hop of the frequency hopping pattern (e.g., a first BW or a first BWP) via which to perform the CLI measurements. In some examples, the UE 115-c may select the first set of frequency resource based on receiving the downlink message at 310.

In some examples, the first downlink message may be any message received via the first set of frequency resources (e.g., control signaling, data signaling, reference signaling, among other examples). The UE 115-c may select the first set of frequency resources via which to perform the CLI measurement based on having received the downlink message most recently via the first set of frequency resources (e.g., the UE 115-c may perform CLI measurement via whichever BW or BWP was most recently used to receive downlink signaling). In such examples, the UE 115-c may monitor the first set of frequency resources for CLI based on the selecting, and may perform CLI measurements based on the monitoring at 320,

In some examples, the first downlink message may be a data message received via a PDSCH of the first set of frequency resources. The UE 115-c may select the first set of frequency resources via which to perform the CLI measurement based on having received the downlink data message most recently via the first set of frequency resources (e.g., the UE 115-c may perform CLI measurement via whichever BW or BWP was most recently used to receive downlink data signaling on a PDSCH). In such examples, the UE 115-c may monitor the first set of frequency resources for CLI based on the selecting, and may perform CLI measurements based on the monitoring at 320.

In some examples, the UE 115-c may autonomously select the BW or BWP on which to perform the CLI measurements (e.g., based on one or more rules, based on a pattern, based on an assignment or instruction from the network entity 105-b, among other examples).

In some examples, the UE 115-c may select the first set of frequency resources, if the first set of frequency resources is an anchor BW or anchor BWP indicated or signaled by the network entity 105-b. For example, the UE 115-c may receive (e.g., from the network entity 105-b at 310) control signaling (e.g., the downlink message) indicating an anchor frequency range (e.g., the first set of frequency resources). The UE 115-c may then select the first set of frequency resources (e.g., the anchor BW or anchor BWP) at 315, and may perform the CLI measurements at 320 via the first set of frequency resources.

In some examples, the UE 115-c may determine that the first set of frequency resources (e.g., the BW or BWP) satisfies a threshold BW supported by the UE 115-c, and may select the first set of frequency resources based on the first set of frequency resources (e.g., the BW or BWP) satisfying the threshold BW supported by the UE 115-c.

At 325, the UE 115-c may perform CLI filtering, and at 330 the UE 115-c may transmit filtered CLI measurements to the network entity 105-b (e.g., in a CLI measurement report). For example, the UE 115-c may select a second set of frequency resources (e.g., at least a second BW or second BWP) at 315, and may perform CLI measurements during the second set of frequency resources at 320.

In some examples, at 325, the UE 115-c may maintain a single filter for each of the first set of frequency resources and the second set of frequency resources (e.g., a single filter for each BW or BWP of the frequency hopping pattern). The UE may include, in the CLI measurement report, a single set of filtered CLI measurements for the range of frequency resources (e.g., a wideband CLI measurement report for a wide band, or a BWP level CLI measurement report for a BWP including multiple BWs).

In some examples, at 325, the UE 115-c may maintain a first filter for the first set of frequency resources and a second filter for the second set of frequency resources (e.g., one filter for each BW or BWP), and may determine a first level of CLI associated with the first filter and a second level of CLI associated with the second filter (e.g., a different set of filtered CLI measurements for each filter). The UE 115-c may include, in the CLI measurement report, the set of filtered CLI measurements that have the highest CLI level.

In some examples, at 325, the UE 115-c may maintain a first filter for the first set of frequency resources and the second set of frequency resources (e.g., a single filter across all BWs or BWPs). The UE 115-c may input into the filter a highest level of CLI associated with a most recent CLI measurement.

At 330, the UE 115-c may transmit the CLI measurement report. The network entity 105-b may receive the CLI measurement report, and interpret the reported filtered CLI measurement. The network entity 105-b may schedule subsequent communications with one or more served UEs 115 (e.g., including the UE 115-c) based on the reported CLI measurement.

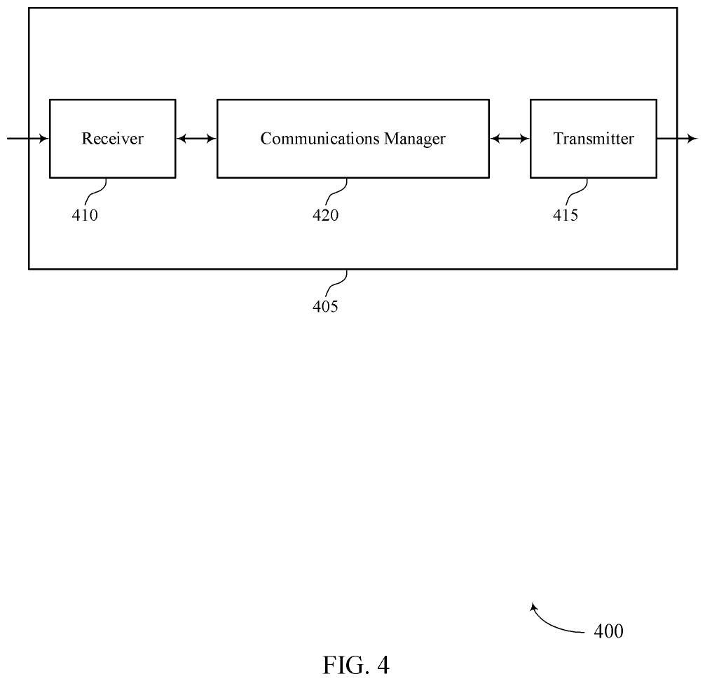

FIG. 4 shows a block diagram 400 of a device 405 that supports CLI measurements for frequency hopping in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to CLI measurements supporting frequency hopping). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to CLI measurements supporting frequency hopping). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of CLI measurements supporting frequency hopping as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software) executed by a processor. If implemented in code executed by a processor, the functions of the communications manager 420, the receiver 410, the transmitter 415, or various combinations or components thereof may be performed by a general-purpose processor, a DSP, a CPU, GPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications at a UE in accordance with examples as disclosed herein. For example, the communications manager 420 may be configured as or otherwise support a means for receiving control signaling indicating a frequency hopping pattern, each frequency hop of the frequency hopping pattern associated with a respective set of frequency resources of a set of multiple frequency resources. The communications manager 420 may be configured as or otherwise support a means for selecting, from the set of multiple frequency resources, a first set of frequency resources associated with a first hop of the frequency hopping pattern on which to perform CLI measurements based on a first downlink message. The communications manager 420 may be configured as or otherwise support a means for performing CLI measurements via the first set of frequency resources.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for CLI measurement and reporting resulting in improved communication reliability, reduced system latency, decreased interference, more efficient use of computational resources, and improved user experience.

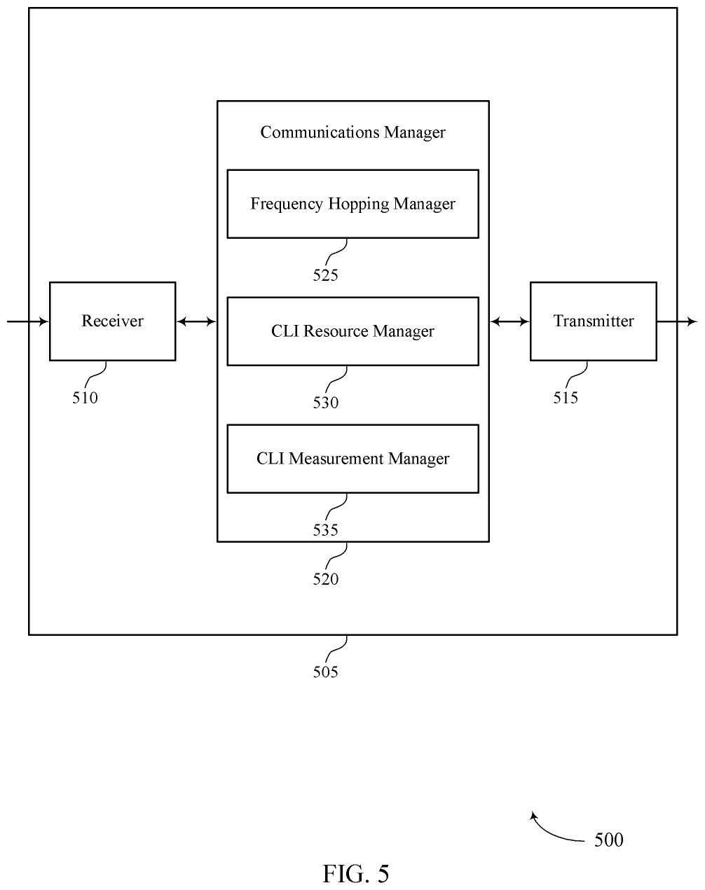

FIG. 5 shows a block diagram 500 of a device 505 that supports CLI measurements for frequency hopping in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to CLI measurements supporting frequency hopping). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to CLI measurements supporting frequency hopping). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of CLI measurements supporting frequency hopping as described herein. For example, the communications manager 520 may include a frequency hopping manager 525, a CLI resource manager 530, a CLI measurement manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. The frequency hopping manager 525 may be configured as or otherwise support a means for receiving control signaling indicating a frequency hopping pattern, each frequency hop of the frequency hopping pattern associated with a respective set of frequency resources of a set of multiple frequency resources. The CLI resource manager 530 may be configured as or otherwise support a means for selecting, from the set of multiple frequency resources, a first set of frequency resources associated with a first hop of the frequency hopping pattern on which to perform CLI measurements based on a first downlink message. The CLI measurement manager 535 may be configured as or otherwise support a means for performing CLI measurements via the first set of frequency resources.

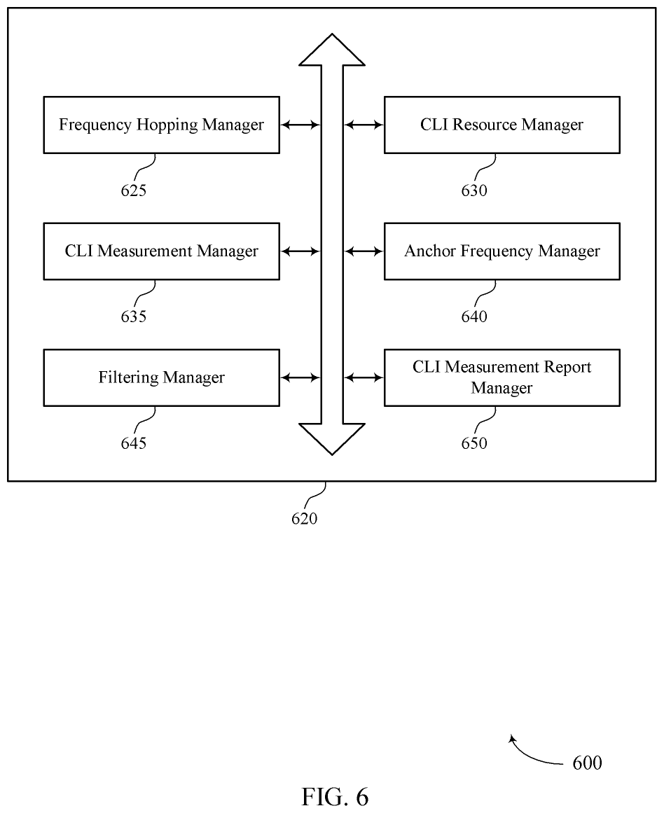

FIG. 6 shows a block diagram 600 of a communications manager 620 that supports CLI measurements for frequency hopping in accordance with one or more aspects of the present disclosure. The communications manager 620 may be an example of aspects of a communications manager 420, a communications manager 520, or both, as described herein. The communications manager 620, or various components thereof, may be an example of means for performing various aspects of CLI measurements supporting frequency hopping as described herein. For example, the communications manager 620 may include a frequency hopping manager 625, a CLI resource manager 630, a CLI measurement manager 635, an anchor frequency manager 640, a filtering manager 645, a CLI measurement report manager 650, or any combination thereof. Each of these components may communicate, directly or indirectly, with one another (e.g., via one or more buses).

The communications manager 620 may support wireless communications at a UE in accordance with examples as disclosed herein. The frequency hopping manager 625 may be configured as or otherwise support a means for receiving control signaling indicating a frequency hopping pattern, each frequency hop of the frequency hopping pattern associated with a respective set of frequency resources of a set of multiple frequency resources. The CLI resource manager 630 may be configured as or otherwise support a means for selecting, from the set of multiple frequency resources, a first set of frequency resources associated with a first hop of the frequency hopping pattern on which to perform CLI measurements based on a first downlink message. The CLI measurement manager 635 may be configured as or otherwise support a means for performing CLI measurements via the first set of frequency resources.

In some examples, the CLI resource manager 630 may be configured as or otherwise support a means for receiving the first downlink message via the first set of frequency resources according to the frequency hopping pattern using a first receive beam, where the selecting is based on receiving the first downlink message via the first set of frequency resources. In some examples, the CLI measurement manager 635 may be configured as or otherwise support a means for monitoring for CLI via the first set of frequency resources using the first receive beam, where performing the CLI measurements is based on the monitoring. In some examples, the first downlink message includes a most recently received downlink message prior to performing the CLI measurements. In some examples, the first downlink message includes a data message received via a downlink shared channel.

In some examples, the anchor frequency manager 640 may be configured as or otherwise support a means for receiving control signaling indicating an anchor frequency range including the first set of frequency resources, where the selecting is based on receiving the control signaling indicating the anchor frequency range. In some examples, the CLI measurement manager 635 may be configured as or otherwise support a means for monitoring for CLI via the first set of frequency resources, where performing the CLI measurements is based on the monitoring.

In some examples, the CLI resource manager 630 may be configured as or otherwise support a means for determining that the first set of frequency resources satisfies a threshold BW supported by the UE, where selecting the first set of frequency resources is based on the receiving.

In some examples, the CLI resource manager 630 may be configured as or otherwise support a means for selecting, from the set of multiple frequency resources, a second set of frequency resources associated with a second hop of the frequency hopping pattern on which to perform CLI measurements. In some examples, the CLI measurement manager 635 may be configured as or otherwise support a means for performing CLI measurements via the second set of frequency resources. In some examples, the filtering manager 645 may be configured as or otherwise support a means for filtering the CLI measurements. In some examples, the CLI measurement report manager 650 may be configured as or otherwise support a means for transmitting a CLI measurement report based on the filtering.

In some examples, to support filtering the CLI measurements, the filtering manager 645 may be configured as or otherwise support a means for maintaining a single filter for each of the first set of frequency resources and the second set of frequency resources, where the CLI measurement report includes a single set of filtered CLI measurements for the set of multiple frequency resources.

In some examples, to support filtering the CLI measurements, the filtering manager 645 may be configured as or otherwise support a means for maintaining a first filter for the first set of frequency resources and a second filter for the second set of frequency resources. In some examples, to support filtering the CLI measurements, the filtering manager 645 may be configured as or otherwise support a means for determining a first level of CLI associated with the first filter and a second level of CLI associated with the second filter, the first level of CLI being higher than the second level of CLI. In some examples, to support filtering the CLI measurements, the CLI measurement report manager 650 may be configured as or otherwise support a means for including, in the CLI measurement report based on the determining, a set of filtered CLI measurements associated with the first filter.

In some examples, to support filtering the CLI measurements, the filtering manager 645 may be configured as or otherwise support a means for maintaining a first filter for the first set of frequency resources and a second filter for the second set of frequency resources. In some examples, to support filtering the CLI measurements, the CLI measurement report manager 650 may be configured as or otherwise support a means for including, in the CLI measurement report, a first set of filtered CLI measurements associated with the first filter and a second set of filtered CLI measurements associated with the second filter.

In some examples, the filtering manager 645 may be configured as or otherwise support a means for maintaining a first filter for the first set of frequency resources and the second set of frequency resources, where an input value for the first filter includes a highest level of cross-channel interference associated with a most recent cross-channel interference measurement for the first set of frequency resources and the second set of frequency resources. In some examples, the set of multiple frequency resources include a BWP and the first set of frequency resources includes a BW within the BWP. In some examples, the set of multiple frequency resources include a set of multiple BWPs and the first set of frequency resources includes a BWP of the set of multiple BWPs.

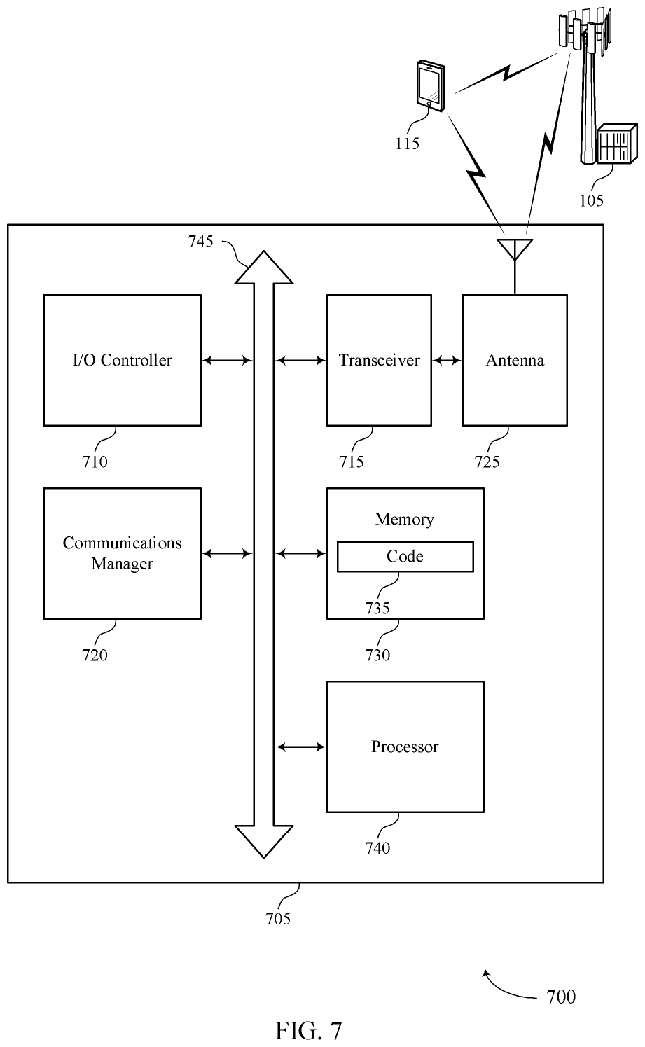

FIG. 7 shows a diagram of a system 700 including a device 705 that supports CLI measurements for frequency hopping in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, GPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting CLI measurements supporting frequency hopping). For example, the device 705 or a component of the device 705 may include a processor 740 and memory 730 coupled with or to the processor 740, the processor 740 and memory 730 configured to perform various functions described herein.

The communications manager 720 may support wireless communications at a UE in accordance with examples as disclosed herein. For example, the communications manager 720 may be configured as or otherwise support a means for receiving control signaling indicating a frequency hopping pattern, each frequency hop of the frequency hopping pattern associated with a respective set of frequency resources of a set of multiple frequency resources. The communications manager 720 may be configured as or otherwise support a means for selecting, from the set of multiple frequency resources, a first set of frequency resources associated with a first hop of the frequency hopping pattern on which to perform CLI measurements based on a first downlink message. The communications manager 720 may be configured as or otherwise support a means for performing CLI measurements via the first set of frequency resources.

By including or configuring the communications manager 720 in accordance with examples as described herein, the device 705 may support techniques for CLI measurement and reporting resulting in improved communication reliability, reduced system latency, decreased interference, and improved user experience.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of CLI measurements supporting frequency hopping as described herein, or the processor 740 and the memory 730 may be otherwise configured to perform or support such operations.

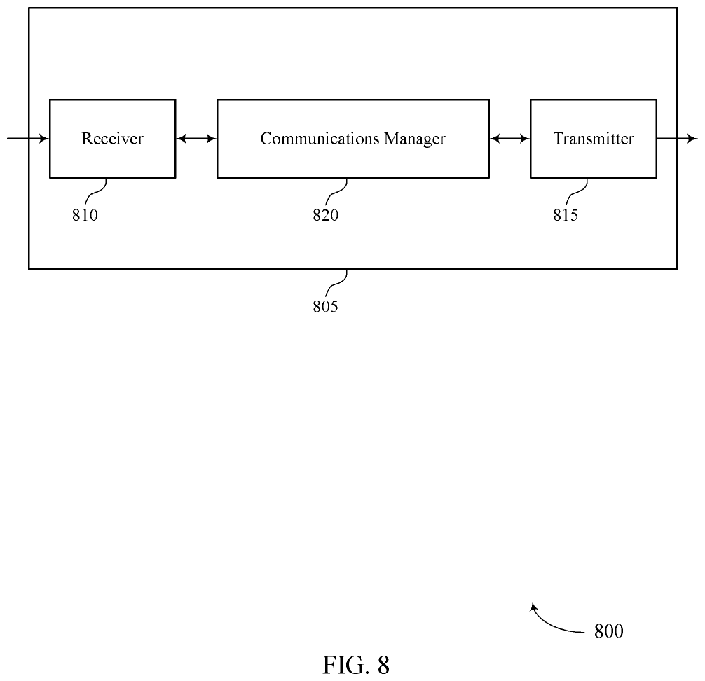

FIG. 8 shows a block diagram 800 of a device 805 that supports CLI measurements for frequency hopping in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of CLI measurements supporting frequency hopping as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software) executed by a processor. If implemented in code executed by a processor, the functions of the communications manager 820, the receiver 810, the transmitter 815, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a network entity in accordance with examples as disclosed herein. For example, the communications manager 820 may be configured as or otherwise support a means for transmitting control signaling indicating a frequency hopping pattern, each frequency hop of the frequency hopping pattern associated with a respective set of frequency resources of a set of multiple frequency resources. The communications manager 820 may be configured as or otherwise support a means for receiving a CLI measurement report corresponding to at least a first set of frequency resources associated with a first hop of the frequency hopping pattern on which a first UE has performed CLI measurements based on a first downlink message. The communications manager 820 may be configured as or otherwise support a means for scheduling wireless communications for a set of multiple UEs including the UE according to the frequency hopping pattern and based on receiving the CLI measurements.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for CLI measurement and reporting resulting in improved communication reliability, reduced system latency, more efficient utilization of computational resources, and improved user experience.

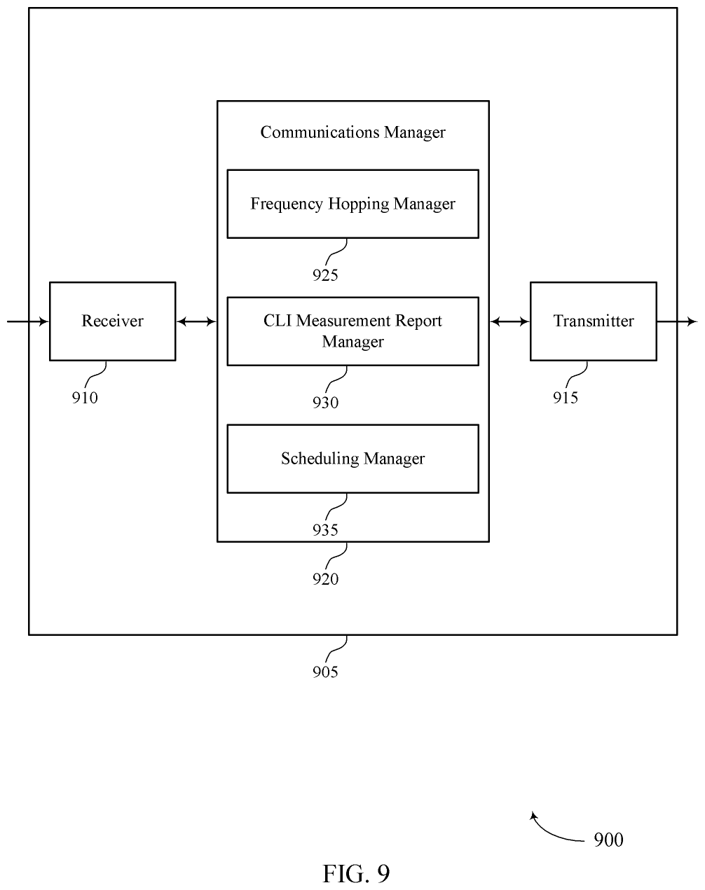

FIG. 9 shows a block diagram 900 of a device 905 that supports CLI measurements for frequency hopping in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of CLI measurements supporting frequency hopping as described herein. For example, the communications manager 920 may include a frequency hopping manager 925, a CLI measurement report manager 930, a scheduling manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. The frequency hopping manager 925 may be configured as or otherwise support a means for transmitting control signaling indicating a frequency hopping pattern, each frequency hop of the frequency hopping pattern associated with a respective set of frequency resources of a set of multiple frequency resources. The CLI measurement report manager 930 may be configured as or otherwise support a means for receiving a CLI measurement report corresponding to at least a first set of frequency resources associated with a first hop of the frequency hopping pattern on which a first UE has performed CLI measurements based on a first downlink message. The scheduling manager 935 may be configured as or otherwise support a means for scheduling wireless communications for a set of multiple UEs including the UE according to the frequency hopping pattern and based on receiving the CLI measurements.

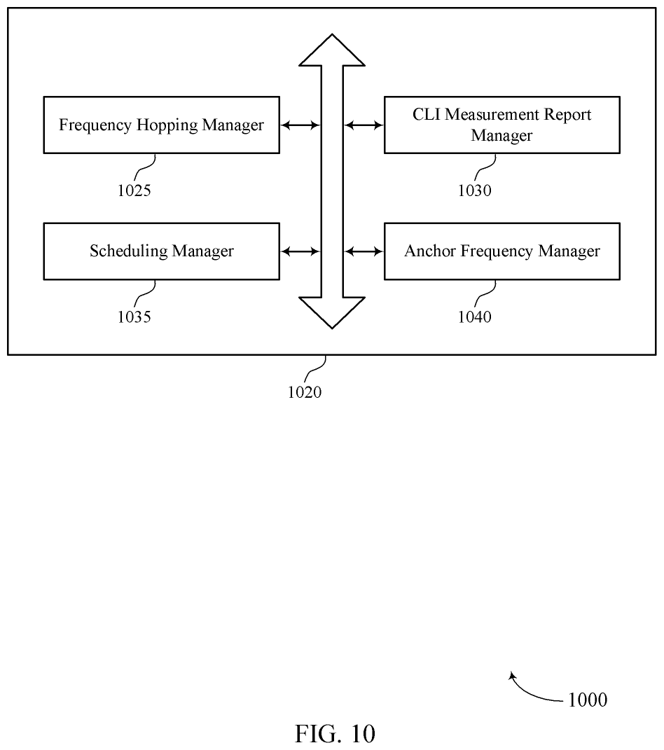

FIG. 10 shows a block diagram 1000 of a communications manager 1020 that supports CLI measurements for frequency hopping in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of CLI measurements supporting frequency hopping as described herein. For example, the communications manager 1020 may include a frequency hopping manager 1025, a CLI measurement report manager 1030, a scheduling manager 1035, an anchor frequency manager 1040, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications at a network entity in accordance with examples as disclosed herein. The frequency hopping manager 1025 may be configured as or otherwise support a means for transmitting control signaling indicating a frequency hopping pattern, each frequency hop of the frequency hopping pattern associated with a respective set of frequency resources of a set of multiple frequency resources. The CLI measurement report manager 1030 may be configured as or otherwise support a means for receiving a CLI measurement report corresponding to at least a first set of frequency resources associated with a first hop of the frequency hopping pattern on which a first UE has performed CLI measurements based on a first downlink message. The scheduling manager 1035 may be configured as or otherwise support a means for scheduling wireless communications for a set of multiple UEs including the UE according to the frequency hopping pattern and based on receiving the CLI measurements.

In some examples, the CLI measurement report manager 1030 may be configured as or otherwise support a means for transmitting the first downlink message via the first set of frequency resources according to the frequency hopping pattern using a first transmit beam, where the CLI measurement report includes CLI measurements performed via the first set of frequency resources based on transmitting the first downlink message via the first set of frequency resources. In some examples, the first downlink message includes a most recently transmitted downlink message prior to a CLI measurement occasion associated with the CLI measurement report. In some examples, the first downlink message includes a data message transmitted via a downlink shared channel.

In some examples, the anchor frequency manager 1040 may be configured as or otherwise support a means for transmitting control signaling indicating an anchor frequency range including the first set of frequency resources, where the CLI measurement report includes CLI measurements performed via the anchor frequency range based on transmitting the control signaling indicating the anchor frequency range. In some examples, the first set of frequency resources satisfies a threshold BW supported by the UE.

In some examples, the CLI measurement report manager 1030 may be configured as or otherwise support a means for receiving a CLI measurement report that includes filtered CLI measurements corresponding to the first set of frequency resources associated with the first hop of the frequency hopping pattern and a second set of frequency resources associated with a second hop of the frequency hopping pattern on which a first UE has performed CLI measurements.

In some examples, the CLI measurement report includes a single set of filtered CLI measurements for the set of multiple frequency resources. In some examples, the CLI measurement report includes a set of filtered CLI measurements associated with a first level of CLI associated with a first filter and the first set of frequency resources, the first level of CLI being higher than a second level of CLI associated with a second filter and the second set of frequency resources. In some examples, the CLI measurement report includes a first set of filtered CLI measurements associated with a first filter and the first set of frequency resources and a second set of filtered CLI measurements associated with a second filter and the second set of frequency resources.

In some examples, the CLI measurement report includes a first set of filtered CLI measurements associated with a first filter and the first set of frequency resources and the second set of frequency resources. In some examples, the first set of filtered CLI measurements is based on a highest level of cross-channel interference associated with a most recent cross-channel interference measurement for the first set of frequency resources and the second set of frequency resources. In some examples, the set of multiple frequency resources include a BWP and the first set of frequency resources includes a BW within the BWP. In some examples, the set of multiple frequency resources include a set of multiple BWPs and the first set of frequency resources includes a BWP of the set of multiple BWPs.

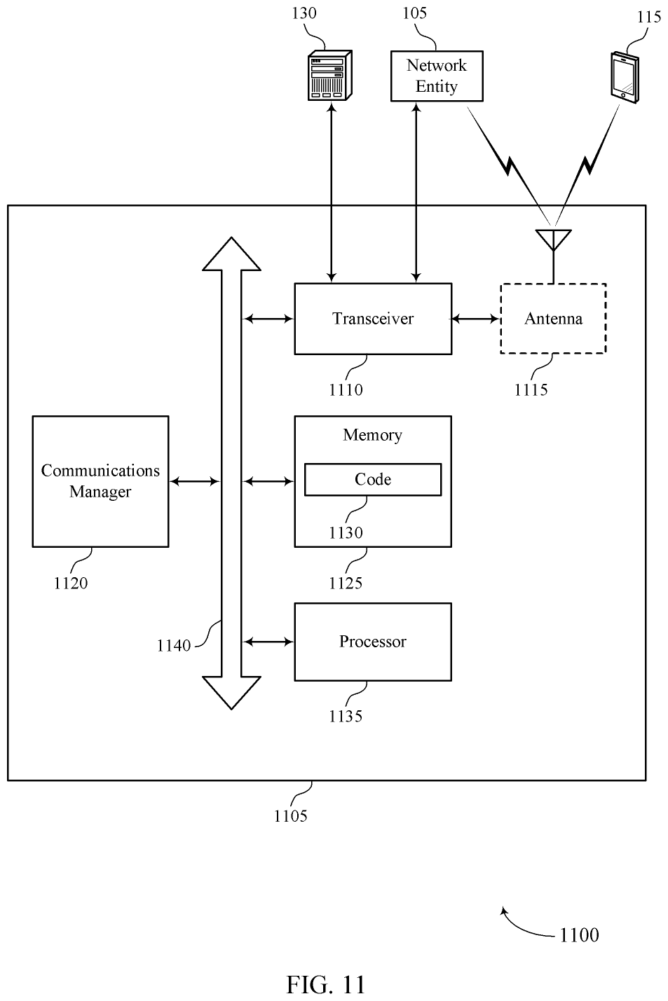

FIG. 11 shows a diagram of a system 1100 including a device 1105 that supports CLI measurements for frequency hopping in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting CLI measurements supporting frequency hopping). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communications at a network entity in accordance with examples as disclosed herein. For example, the communications manager 1120 may be configured as or otherwise support a means for transmitting control signaling indicating a frequency hopping pattern, each frequency hop of the frequency hopping pattern associated with a respective set of frequency resources of a set of multiple frequency resources. The communications manager 1120 may be configured as or otherwise support a means for receiving a CLI measurement report corresponding to at least a first set of frequency resources associated with a first hop of the frequency hopping pattern on which a first UE has performed CLI measurements based on a first downlink message. The communications manager 1120 may be configured as or otherwise support a means for scheduling wireless communications for a set of multiple UEs including the UE according to the frequency hopping pattern and based on receiving the CLI measurements.

By including or configuring the communications manager 1120 in accordance with examples as described herein, the device 1105 may support techniques for CLI measurement and reporting resulting in improved communication reliability, reduced system latency, decreased interference, and improved user experience.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of CLI measurements supporting frequency hopping as described herein, or the processor 1135 and the memory 1125 may be otherwise configured to perform or support such operations.

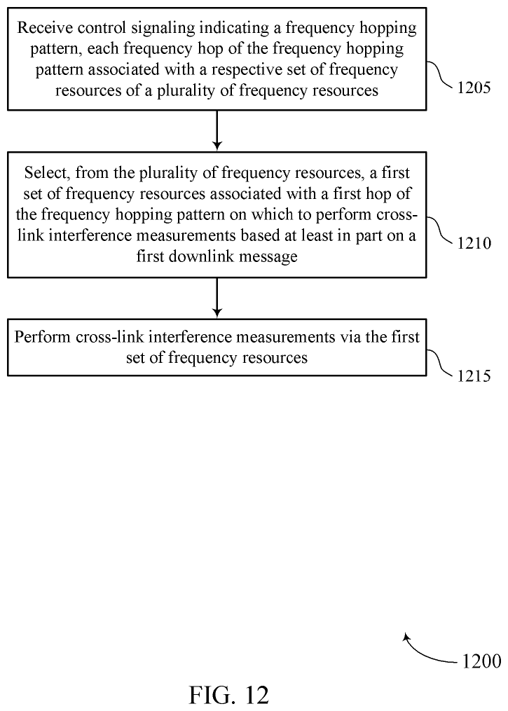

FIG. 12 shows a flowchart illustrating a method 1200 that supports CLI measurements for frequency hopping in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving control signaling indicating a frequency hopping pattern, each frequency hop of the frequency hopping pattern associated with a respective set of frequency resources of a set of multiple frequency resources. The operations of 1205 may be performed in accordance with examples as disclosed herein. In some examples, aspects of the operations of 1205 may be performed by a frequency hopping manager 625 as described with reference to FIG. 6.

At 1210, the method may include selecting, from the set of multiple frequency resources, a first set of frequency resources associated with a first hop of the frequency hopping pattern on which to perform CLI measurements based at least in part on a first downlink message. The operations of 1210 may be performed in accordance with examples as disclosed herein. In some examples, aspects of the operations of 1210 may be performed by a CLI resource manager 630 as described with reference to FIG. 6.

At 1215, the method may include performing CLI measurements via the first set of frequency resources. The operations of 1215 may be performed in accordance with examples as disclosed herein. In some examples, aspects of the operations of 1215 may be performed by a CLI measurement manager 635 as described with reference to FIG. 6.

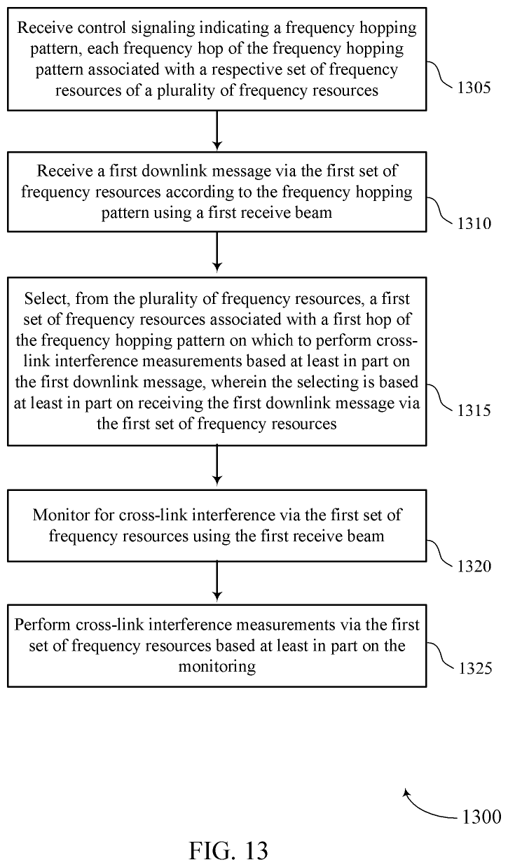

FIG. 13 shows a flowchart illustrating a method 1300 that supports CLI measurements for frequency hopping in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving control signaling indicating a frequency hopping pattern, each frequency hop of the frequency hopping pattern associated with a respective set of frequency resources of a set of multiple frequency resources. The operations of 1305 may be performed in accordance with examples as disclosed herein. In some examples, aspects of the operations of 1305 may be performed by a frequency hopping manager 625 as described with reference to FIG. 6.

At 1310, the method may include receiving a first downlink message via the first set of frequency resources according to the frequency hopping pattern using a first receive beam. The operations of 1310 may be performed in accordance with examples as disclosed herein. In some examples, aspects of the operations of 1310 may be performed by a CLI resource manager 630 as described with reference to FIG. 6.

At 1315, the method may include selecting, from the set of multiple frequency resources, a first set of frequency resources associated with a first hop of the frequency hopping pattern on which to perform CLI measurements based at least in part on the first downlink message, where the selecting is based at least in part on receiving the first downlink message via the first set of frequency resources. The operations of 1315 may be performed in accordance with examples as disclosed herein. In some examples, aspects of the operations of 1315 may be performed by a CLI resource manager 630 as described with reference to FIG. 6.

At 1320, the method may include monitoring for CLI via the first set of frequency resources using the first receive beam. The operations of 1320 may be performed in accordance with examples as disclosed herein. In some examples, aspects of the operations of 1320 may be performed by a CLI measurement manager 635 as described with reference to FIG. 6.

At 1325, the method may include performing CLI measurements via the first set of frequency resources based at least in part on the monitoring. The operations of 1325 may be performed in accordance with examples as disclosed herein. In some examples, aspects of the operations of 1325 may be performed by a CLI measurement manager 635 as described with reference to FIG. 6.

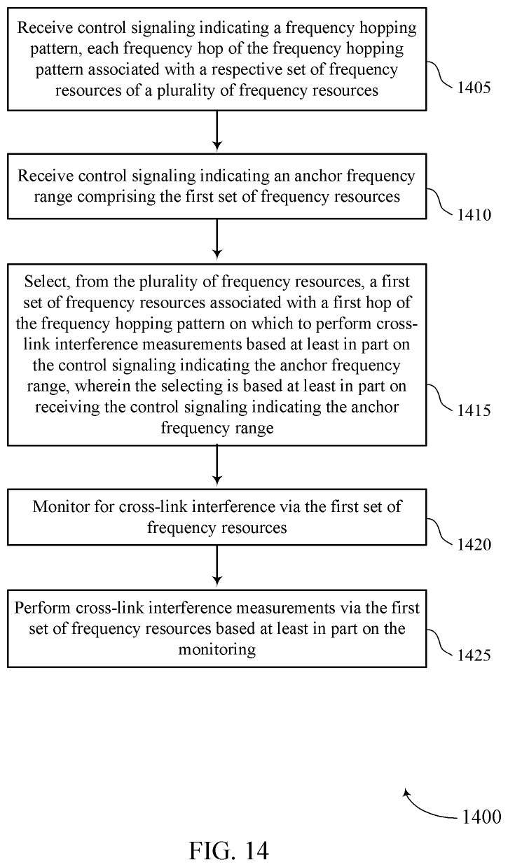

FIG. 14 shows a flowchart illustrating a method 1400 that supports CLI measurements for frequency hopping in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving control signaling indicating a frequency hopping pattern, each frequency hop of the frequency hopping pattern associated with a respective set of frequency resources of a set of multiple frequency resources. The operations of 1405 may be performed in accordance with examples as disclosed herein. In some examples, aspects of the operations of 1405 may be performed by a frequency hopping manager 625 as described with reference to FIG. 6.

At 1410, the method may include receiving control signaling indicating an anchor frequency range including the first set of frequency resources. The operations of 1410 may be performed in accordance with examples as disclosed herein. In some examples, aspects of the operations of 1410 may be performed by an anchor frequency manager 640 as described with reference to FIG. 6.

At 1415, the method may include selecting, from the plurality of frequency resources, a first set of frequency resources associated with a first hop of the frequency hopping pattern on which to perform CLI measurements based at least in part on the control signaling indicating the anchor frequency range, wherein the selecting is based at least in part on receiving the control signaling indicating the anchor frequency range. The operations of 1415 may be performed in accordance with examples as disclosed herein. In some examples, aspects of the operations of 1415 may be performed by a CLI resource manager 630 as described with reference to FIG. 6.

At 1420, the method may include monitoring for CLI via the first set of frequency resources. The operations of 1420 may be performed in accordance with examples as disclosed herein. In some examples, aspects of the operations of 1420 may be performed by a CLI measurement manager 635 as described with reference to FIG. 6.

At 1425, the method may include performing CLI measurements via the first set of frequency resources based at least in part on the monitoring. The operations of 1425 may be performed in accordance with examples as disclosed herein. In some examples, aspects of the operations of 1425 may be performed by a CLI measurement manager 635 as described with reference to FIG. 6.

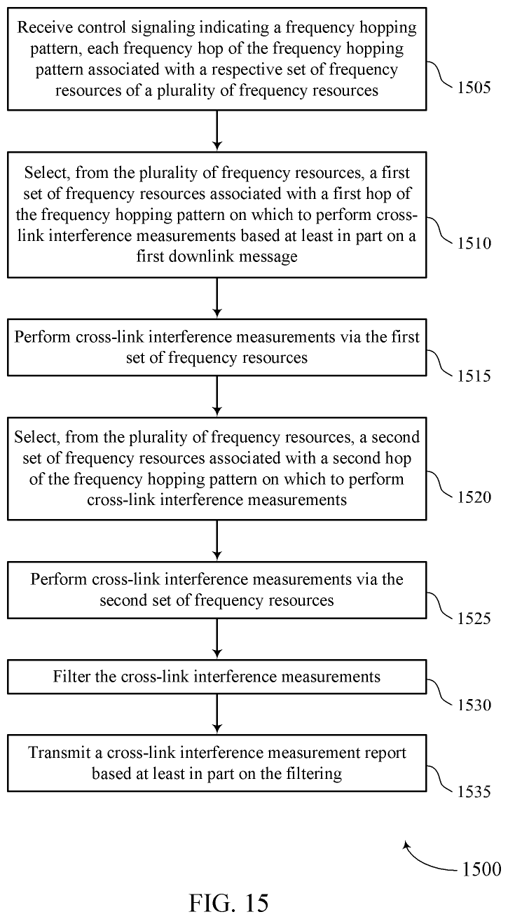

FIG. 15 shows a flowchart illustrating a method 1500 that supports CLI measurements for frequency hopping in accordance with one or more aspects of the present disclosure. The operations of the method 1500 may be implemented by a UE or its components as described herein. For example, the operations of the method 1500 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1505, the method may include receiving control signaling indicating a frequency hopping pattern, each frequency hop of the frequency hopping pattern associated with a respective set of frequency resources of a set of multiple frequency resources. The operations of 1505 may be performed in accordance with examples as disclosed herein. In some examples, aspects of the operations of 1505 may be performed by a frequency hopping manager 625 as described with reference to FIG. 6.

At 1510, the method may include selecting, from the set of multiple frequency resources, a first set of frequency resources associated with a first hop of the frequency hopping pattern on which to perform CLI measurements based on a first downlink message. The operations of 1510 may be performed in accordance with examples as disclosed herein. In some examples, aspects of the operations of 1510 may be performed by a CLI resource manager 630 as described with reference to FIG. 6.

At 1515, the method may include performing CLI measurements via the first set of frequency resources. The operations of 1515 may be performed in accordance with examples as disclosed herein. In some examples, aspects of the operations of 1515 may be performed by a CLI measurement manager 635 as described with reference to FIG. 6.

At 1520, the method may include selecting, from the set of multiple frequency resources, a second set of frequency resources associated with a second hop of the frequency hopping pattern on which to perform CLI measurements. The operations of 1520 may be performed in accordance with examples as disclosed herein. In some examples, aspects of the operations of 1520 may be performed by a CLI resource manager 630 as described with reference to FIG. 6.

At 1525, the method may include performing CLI measurements via the second set of frequency resources. The operations of 1525 may be performed in accordance with examples as disclosed herein. In some examples, aspects of the operations of 1525 may be performed by a CLI measurement manager 635 as described with reference to FIG. 6.

At 1530, the method may include filtering the CLI measurements. The operations of 1530 may be performed in accordance with examples as disclosed herein. In some examples, aspects of the operations of 1530 may be performed by a filtering manager 645 as described with reference to FIG. 6.

At 1535, the method may include transmitting a CLI measurement report based on the filtering. The operations of 1535 may be performed in accordance with examples as disclosed herein. In some examples, aspects of the operations of 1535 may be performed by a CLI measurement report manager 650 as described with reference to FIG. 6.

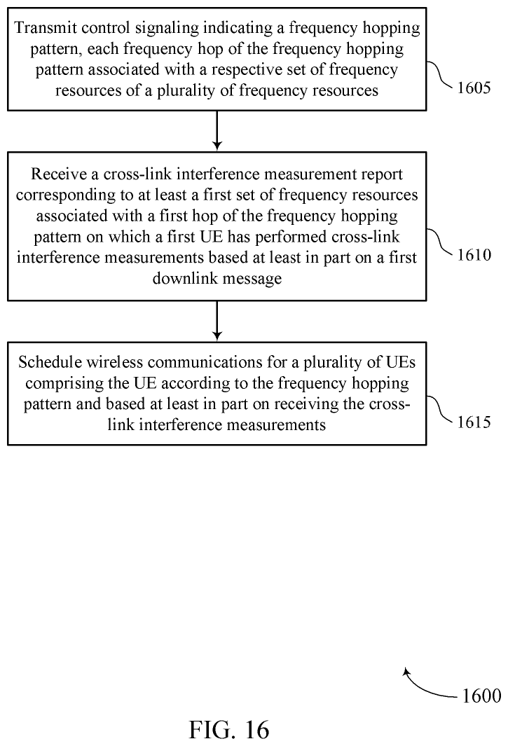

FIG. 16 shows a flowchart illustrating a method 1600 that supports CLI measurements for frequency hopping in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include transmitting control signaling indicating a frequency hopping pattern, each frequency hop of the frequency hopping pattern associated with a respective set of frequency resources of a set of multiple frequency resources. The operations of 1605 may be performed in accordance with examples as disclosed herein. In some examples, aspects of the operations of 1605 may be performed by a frequency hopping manager 1025 as described with reference to FIG. 10.

At 1610, the method may include receiving a CLI measurement report corresponding to at least a first set of frequency resources associated with a first hop of the frequency hopping pattern on which a first UE has performed CLI measurements based on a first downlink message. The operations of 1610 may be performed in accordance with examples as disclosed herein. In some examples, aspects of the operations of 1610 may be performed by a CLI measurement report manager 1030 as described with reference to FIG. 10.

At 1615, the method may include scheduling wireless communications for a set of multiple UEs including the UE according to the frequency hopping pattern and based on receiving the CLI measurements. The operations of 1615 may be performed in accordance with examples as disclosed herein. In some examples, aspects of the operations of 1615 may be performed by a scheduling manager 1035 as described with reference to FIG. 10.

The following provides an overview of aspects of the present disclosure:

Aspect 1: A method for wireless communications at a UE, comprising: receiving control signaling indicating a frequency hopping pattern, each frequency hop of the frequency hopping pattern associated with a respective set of frequency resources of a plurality of frequency resources; selecting, from the plurality of frequency resources, a first set of frequency resources associated with a first hop of the frequency hopping pattern on which to perform cross-link interference measurements based at least in part on a first downlink message; and performing cross-link interference measurements via the first set of frequency resources.

Aspect 2: The method of aspect 1, further comprising: receiving the first downlink message via the first set of frequency resources according to the frequency hopping pattern using a first receive beam, wherein the selecting is based at least in part on receiving the first downlink message via the first set of frequency resources; and monitoring for cross-link interference via the first set of frequency resources using the first receive beam, wherein performing the cross-link interference measurements is based at least in part on the monitoring.

Aspect 3: The method of aspect 2, wherein the first downlink message comprises most recently received downlink message prior to performing the cross-link interference measurements.

Aspect 4: The method of aspect 3, wherein the first downlink message comprises a data message received via a downlink shared channel.

Aspect 5: The method of any of aspects 1 through 4, further comprising: receiving control signaling indicating an anchor frequency range comprising the first set of frequency resources, wherein the selecting is based at least in part on receiving the control signaling indicating the anchor frequency range; and monitoring for cross-link interference via the first set of frequency resources, wherein performing the cross-link interference measurements is based at least in part on the monitoring.

Aspect 6: The method of any of aspects 1 through 5, further comprising: determining that the first set of frequency resources satisfies a threshold bandwidth supported by the UE, wherein selecting the first set of frequency resources is based at least in part on the receiving.

Aspect 7: The method of any of aspects 1 through 6, further comprising: selecting, from the plurality of frequency resources, a second set of frequency resources associated with a second hop of the frequency hopping pattern on which to perform cross-link interference measurements; performing cross-link interference measurements via the second set of frequency resources; filtering the cross-link interference measurements; and transmitting a cross-link interference measurement report based at least in part on the filtering.

Aspect 8: The method of aspect 7, wherein filtering the cross-link interference measurements comprises: maintaining a single filter for each of the first set of frequency resources and the second set of frequency resources, wherein the cross-link interference measurement report comprises a single set of filtered cross-link interference measurements for the plurality of frequency resources.

Aspect 9: The method of any of aspects 7 through 8, wherein filtering the cross-link interference measurements comprises: maintaining a first filter for the first set of frequency resources and a second filter for the second set of frequency resources; determining a first level of cross-link interference associated with the first filter and a second level of cross-link interference associated with the second filter, the first level of cross-link interference being higher than the second level of cross-link interference; and including, in the cross-link interference measurement report based at least in part on the determining, a set of filtered cross-link interference measurements associated with the first filter.

Aspect 10: The method of any of aspects 7 through 9, wherein filtering the cross-link interference measurements comprises: maintaining a first filter for the first set of frequency resources and a second filter for the second set of frequency resources; and including, in the cross-link interference measurement report, a first set of filtered cross-link interference measurements associated with the first filter and a second set of filtered cross-link interference measurements associated with the second filter.

Aspect 11: The method of any of aspects 7 through 10, further comprising: maintaining a first filter for the first set of frequency resources and the second set of frequency resources, wherein an input value for the first filter comprises a highest level of cross-channel interference associated with a most recent cross-channel interference measurement for the first set of frequency resources and the second set of frequency resources.

Aspect 12: The method of any of aspects 1 through 11, wherein the plurality of frequency resources comprise a bandwidth part and the first set of frequency resources comprises a bandwidth within the bandwidth part.

Aspect 13: The method of any of aspects 1 through 12, wherein the plurality of frequency resources comprise a plurality of bandwidth parts and the first set of frequency resources comprises a bandwidth part of the plurality of bandwidth parts.

Aspect 14: A method for wireless communications at a network entity, comprising: transmitting control signaling indicating a frequency hopping pattern, each frequency hop of the frequency hopping pattern associated with a respective set of frequency resources of a plurality of frequency resources; receiving a cross-link interference measurement report corresponding to at least a first set of frequency resources associated with a first hop of the frequency hopping pattern on which a first UE has performed cross-link interference measurements based at least in part on a first downlink message; and scheduling wireless communications for a plurality of UEs comprising the UE according to the frequency hopping pattern and based at least in part on receiving the cross-link interference measurement report.

Aspect 15: The method of aspect 14, further comprising: transmitting the first downlink message via the first set of frequency resources according to the frequency hopping pattern using a first transmit beam, wherein the cross-link interference measurement report comprises cross-link interference measurements performed via the first set of frequency resources based at least in part on transmitting the first downlink message via the first set of frequency resources.

Aspect 16: The method of aspect 15, wherein the first downlink message comprises most recently transmitted downlink message prior to a cross-link interference measurement occasion associated with the cross-link interference measurement report.

Aspect 17: The method of aspect 16, wherein the first downlink message comprises a data message transmitted via a downlink shared channel.

Aspect 18: The method of any of aspects 14 through 17, further comprising: transmitting control signaling indicating an anchor frequency range comprising the first set of frequency resources, wherein the cross-link interference measurement report comprises cross-link interference measurements performed via the anchor frequency range based at least in part on transmitting the control signaling indicating the anchor frequency range.

Aspect 19: The method of any of aspects 14 through 18, wherein the first set of frequency resources satisfies a threshold bandwidth supported by the UE.

Aspect 20: The method of any of aspects 14 through 19, further comprising: wherein the cross-link interference measurement report comprises filtered cross-link interference measurements corresponding to the first set of frequency resources associated with the first hop of the frequency hopping pattern and a second set of frequency resources associated with a second hop of the frequency hopping pattern on which a first UE has performed cross-link interference measurements.

Aspect 21: The method of aspect 20, wherein the cross-link interference measurement report comprises a single set of filtered cross-link interference measurements for the plurality of frequency resources.

Aspect 22: The method of any of aspects 20 through 21, wherein the cross-link interference measurement report comprises a set of filtered cross-link interference measurements associated with a first level of cross-link interference associated with a first filter and the first set of frequency resources, the first level of cross-link interference being higher than a second level of cross-link interference associated with a second filter and the second set of frequency resources.

Aspect 23: The method of any of aspects 20 through 22, wherein the cross-link interference measurement report comprises a first set of filtered cross-link interference measurements associated with a first filter and the first set of frequency resources and a second set of filtered cross-link interference measurements associated with a second filter and the second set of frequency resources.

Aspect 24: The method of any of aspects 20 through 23, wherein the cross-link interference measurement report comprises a first set of filtered cross-link interference measurements associated with a first filter and the first set of frequency resources and the second set of frequency resources, the first set of filtered cross-link interference measurements is based at least in part on a highest level of cross-channel interference associated with a most recent cross-channel interference measurement for the first set of frequency resources and the second set of frequency resources.

Aspect 25: The method of any of aspects 14 through 24, wherein the plurality of frequency resources comprise a bandwidth part and the first set of frequency resources comprises a bandwidth within the bandwidth part.

Aspect 26: The method of any of aspects 14 through 25, wherein the plurality of frequency resources comprise a plurality of bandwidth parts and the first set of frequency resources comprises a bandwidth part of the plurality of bandwidth parts.

Aspect 27: An apparatus for wireless communications at a UE, comprising at least one processor; memory coupled with the at least one processor; and instructions stored in the memory and executable by the at least one processor to cause the UE to perform a method of any of aspects 1 through 13.

Aspect 28: An apparatus for wireless communications at a UE, comprising at least one means for performing a method of any of aspects 1 through 13.

Aspect 29: A non-transitory computer-readable medium storing code for wireless communications at a UE, the code comprising instructions executable by at least one processor to perform a method of any of aspects 1 through 13.

Aspect 30: An apparatus for wireless communications at a network entity, comprising at least one processor; memory coupled with the at least one processor; and instructions stored in the memory and executable by the at least one processor to cause the network entity to perform a method of any of aspects 14 through 26.

Aspect 31: An apparatus for wireless communications at a network entity, comprising at least one means for performing a method of any of aspects 14 through 26.

Aspect 32: A non-transitory computer-readable medium storing code for wireless communications at a network entity, the code comprising instructions executable by at least one processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non- transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
memory coupled to the at least one processor, the memory storing instructions executable by the at least one processor to cause the UE to:
receive control signaling indicating a frequency hopping pattern, each frequency hop of the frequency hopping pattern associated with a respective set of frequency resources of a plurality of frequency resources;
select, from the plurality of frequency resources, a first set of frequency resources associated with a first hop of the frequency hopping pattern on which to perform cross-link interference measurements based at least in part on a first downlink message; and
perform cross-link interference measurements via the first set of frequency resources.

2. The apparatus of claim 1, wherein the instructions are further executable by the at least one processor to cause the UE to:
receive the first downlink message via the first set of frequency resources according to the frequency hopping pattern using a first receive beam, wherein the selecting is based at least in part on receiving the first downlink message via the first set of frequency resources; and
monitor for cross-link interference via the first set of frequency resources using the first receive beam, wherein performing the cross-link interference measurements is based at least in part on the monitoring.

3. The apparatus of claim 2, wherein the first downlink message comprises a most recently received downlink message prior to performing the cross-link interference measurements.

4. The apparatus of claim 3, wherein the first downlink message comprises a data message received via a downlink shared channel.

5. The apparatus of claim 1, wherein the instructions are further executable by the at least one processor to cause the UE to:
receive control signaling indicating an anchor frequency range comprising the first set of frequency resources, wherein the selecting is based at least in part on receiving the control signaling indicating the anchor frequency range; and
monitor for cross-link interference via the first set of frequency resources, wherein performing the cross-link interference measurements is based at least in part on the monitoring.

6. The apparatus of claim 1, wherein the instructions are further executable by the at least one processor to cause the UE to:
determine that the first set of frequency resources satisfies a threshold bandwidth supported by the UE, wherein selecting the first set of frequency resources is based at least in part on the receiving.

7. The apparatus of claim 1, wherein the instructions are further executable by the at least one processor to cause the UE to:
select, from the plurality of frequency resources, a second set of frequency resources associated with a second hop of the frequency hopping pattern on which to perform cross-link interference measurements;
perform cross-link interference measurements via the second set of frequency resources;
filter the cross-link interference measurements; and
transmit a cross-link interference measurement report based at least in part on the filtering.

8. The apparatus of claim 7, wherein the instructions to filter the cross-link interference measurements are executable by the at least one processor to cause the UE to:
maintain a single filter for each of the first set of frequency resources and the second set of frequency resources, wherein the cross-link interference measurement report comprises a single set of filtered cross-link interference measurements for the plurality of frequency resources.

9. The apparatus of claim 7, wherein the instructions to filter the cross-link interference measurements are executable by the at least one processor to cause the UE to:
maintain a first filter for the first set of frequency resources and a second filter for the second set of frequency resources;
determine a first level of cross-link interference associated with the first filter and a second level of cross-link interference associated with the second filter, the first level of cross-link interference being higher than the second level of cross-link interference; and
include, in the cross-link interference measurement report based at least in part on the determining, a set of filtered cross-link interference measurements associated with the first filter.

10. The apparatus of claim 7, wherein the instructions to filter the cross-link interference measurements are executable by the at least one processor to cause the UE to:
maintain a first filter for the first set of frequency resources and a second filter for the second set of frequency resources; and
include, in the cross-link interference measurement report, a first set of filtered cross-link interference measurements associated with the first filter and a second set of filtered cross-link interference measurements associated with the second filter.

11. The apparatus of claim 7, wherein the instructions are further executable by the at least one processor to cause the UE to:
maintain a first filter for the first set of frequency resources and the second set of frequency resources, wherein an input value for the first filter comprises a highest level of cross-channel interference associated with a most recent cross-channel interference measurement for the first set of frequency resources and the second set of frequency resources.

12. The apparatus of claim 1, wherein the plurality of frequency resources comprises a bandwidth part and the first set of frequency resources comprises a bandwidth within the bandwidth part.

13. The apparatus of claim 1, wherein the plurality of frequency resources comprises a plurality of bandwidth parts and the first set of frequency resources comprises a bandwidth part of the plurality of bandwidth parts.

14. An apparatus for wireless communications at a network entity, comprising:
at least one processor; and
memory coupled to the at least one processor, the memory storing instructions executable by the at least one processor to cause the network entity to:
transmit control signaling indicating a frequency hopping pattern, each frequency hop of the frequency hopping pattern associated with a respective set of frequency resources of a plurality of frequency resources;
receive a cross-link interference measurement report corresponding to at least a first set of frequency resources associated with a first hop of the frequency hopping pattern on which a first user equipment (UE) has performed cross-link interference measurements based at least in part on a first downlink message; and
schedule wireless communications for a plurality of UEs comprising the UE according to the frequency hopping pattern and based at least in part on receiving the cross-link interference measurement report.

15. The apparatus of claim 14, wherein the instructions are further executable by the at least one processor to cause the network entity to:
transmit the first downlink message via the first set of frequency resources according to the frequency hopping pattern using a first transmit beam, wherein the cross-link interference measurement report comprises cross-link interference measurements performed via the first set of frequency resources based at least in part on transmitting the first downlink message via the first set of frequency resources.

16. The apparatus of claim 15, wherein the first downlink message comprises a most recently transmitted downlink message prior to a cross-link interference measurement occasion associated with the cross-link interference measurement report.

17. The apparatus of claim 16, wherein the first downlink message comprises a data message transmitted via a downlink shared channel.

18. The apparatus of claim 14, wherein the instructions are further executable by the at least one processor to cause the network entity to:
transmit control signaling indicating an anchor frequency range comprising the first set of frequency resources, wherein the cross-link interference measurement report comprises cross-link interference measurements performed via the anchor frequency range based at least in part on transmitting the control signaling indicating the anchor frequency range.

19. The apparatus of claim 14, wherein the first set of frequency resources satisfies a threshold bandwidth supported by the UE.

20. The apparatus of claim 14, wherein the cross-link interference measurement report comprises filtered cross-link interference measurements corresponding to the first set of frequency resources associated with the first hop of the frequency hopping pattern and a second set of frequency resources associated with a second hop of the frequency hopping pattern on which a first UE has performed cross-link interference measurements.

21. The apparatus of claim 20, wherein the cross-link interference measurement report comprises a single set of filtered cross-link interference measurements for the plurality of frequency resources.

22. The apparatus of claim 20, wherein the cross-link interference measurement report comprises a set of filtered cross-link interference measurements associated with a first level of cross-link interference associated with a first filter and the first set of frequency resources, the first level of cross-link interference being higher than a second level of cross-link interference associated with a second filter and the second set of frequency resources.

23. The apparatus of claim 20, wherein the cross-link interference measurement report comprises a first set of filtered cross-link interference measurements associated with a first filter and the first set of frequency resources and a second set of filtered cross-link interference measurements associated with a second filter and the second set of frequency resources.

24. The apparatus of claim 20, wherein the cross-link interference measurement report comprises a first set of filtered cross-link interference measurements associated with a first filter and the first set of frequency resources and the second set of frequency resources, and the first set of filtered cross-link interference measurements is based at least in part on a highest level of cross-channel interference associated with a most recent cross-channel interference measurement for the first set of frequency resources and the second set of frequency resources.

25. The apparatus of claim 14, wherein the plurality of frequency resources comprises a bandwidth part and the first set of frequency resources comprises a bandwidth within the bandwidth part.

26. The apparatus of claim 14, wherein the plurality of frequency resources comprises a plurality of bandwidth parts and the first set of frequency resources comprises a bandwidth part of the plurality of bandwidth parts.

27. A method for wireless communications at a user equipment (UE), comprising:
receiving control signaling indicating a frequency hopping pattern, each frequency hop of the frequency hopping pattern associated with a respective set of frequency resources of a plurality of frequency resources;
selecting, from the plurality of frequency resources, a first set of frequency resources associated with a first hop of the frequency hopping pattern on which to perform cross-link interference measurements based at least in part on a first downlink message; and
performing cross-link interference measurements via the first set of frequency resources.

28. The method of claim 27, further comprising:
receiving the first downlink message via the first set of frequency resources according to the frequency hopping pattern using a first receive beam, wherein the selecting is based at least in part on receiving the first downlink message via the first set of frequency resources; and
monitoring for cross-link interference via the first set of frequency resources using the first receive beam, wherein performing the cross-link interference measurements is based at least in part on the monitoring.

29. The method of claim 27, further comprising:
receiving control signaling indicating an anchor frequency range comprising the first set of frequency resources, wherein the selecting is based at least in part on receiving the control signaling indicating the anchor frequency range; and
monitoring for cross-link interference via the first set of frequency resources, wherein performing the cross-link interference measurements is based at least in part on the monitoring.

30. A method for wireless communications at a network entity, comprising:
transmitting control signaling indicating a frequency hopping pattern, each frequency hop of the frequency hopping pattern associated with a respective set of frequency resources of a plurality of frequency resources;
receiving a cross-link interference measurement report corresponding to at least a first set of frequency resources associated with a first hop of the frequency hopping pattern on which a first user equipment (UE) has performed cross-link interference measurements based at least in part on a first downlink message; and
scheduling wireless communications for a plurality of UEs comprising the UE according to the frequency hopping pattern and based at least in part on receiving the cross-link interference measurement report.
